(19) United States
(12) Patent Application Publication
(10) Pub. No.: US 2026/0228859 A1
(43) Pub. Date: Aug. 6, 2026

(54) METHOD AND SYSTEM FOR FORMING FOVEATED IMAGES BASED ON EYE GAZE

(71) Applicant: Magic Leap, Inc., Plantation, FL (US)

(72) Inventors: Edward Diaz, Hialeah, FL (US); Kevin Maurice Irick, Orangeburg, SC (US)

(73) Assignee: Magic Leap, Inc., Plantation, FL (US)

(21) Appl. No.: 19/578,600

(22) Filed: Mar. 25, 2026

Related U.S. Application Data
(63) Continuation of application No. PCT/US2024/050823, filed on Oct. 10, 2024.
(60) Provisional application No. 63/543,876, filed on Oct. 12, 2023.
(60) Provisional application No. 63/543,877, filed on Oct. 12, 2023.

(51) Int. Cl. G06T 5/50; G06T 7/10; G06T 7/70

(52) U.S. Cl. CPC G06T 5/50; G06T 7/10; G06T 7/70; G06T 2207/20221

(57) ABSTRACT

A method includes rendering an original image at a first processor, encoding the original image to provide an encoded image, and transmitting the encoded image to a second processor. The method also includes decoding the encoded image to provide a decoded image, determining an eye gaze location, splitting the decoded image into N sections based on the eye gaze location, and processing N-1 sections of the N sections to produce N-1 secondary quality sections. The method further includes processing one section of the N sections to provide one primary quality section, combining the one primary quality section and the N-1 secondary quality sections to form a foveated image, and transmitting the foveated image to a display.

### CROSS-REFERENCES TO RELATED APPLICATIONS

This application is a continuation of International Patent Application No. PCT/US2024/050823, filed Oct. 10, 2024, entitled “METHOD AND SYSTEM FOR FORMING FOVEATED IMAGES BASED ON EYE GAZE,” which claims the benefit of and priority to U.S. Provisional Patent Application No. 63/543,876, filed Oct. 12, 2023, entitled “METHOD AND SYSTEM FOR PERFORMING DYNAMIC FOVEATION BASED ON EYE GAZE,” and U.S. Provisional Patent Application No. 63/543,877, filed Oct. 12, 2023, entitled “METHOD AND SYSTEM FOR FORMING FOVEATED IMAGES BASED ON EYE GAZE,” the entire contents of which are hereby incorporated by reference for all purposes.

### BACKGROUND OF THE INVENTION

Modern computing and display technologies have facilitated the development of systems for so called “virtual reality” or “augmented reality” experiences, wherein digitally reproduced images or portions thereof are presented to a viewer in a manner wherein they seem to be, or may be perceived as, real. A virtual reality, or “VR,” scenario typically involves presentation of digital or virtual image information without transparency to other actual real-world visual input; an augmented reality, or “AR,” scenario typically involves presentation of digital or virtual image information as an augmentation to visualization of the actual world around the viewer.

Despite the progress made in these display technologies, there is a need in the art for improved methods and systems related to augmented reality systems, particularly, display systems.

### SUMMARY OF THE INVENTION

The present invention relates generally to methods and systems related to projection display systems including wearable displays. More particularly, embodiments of the present invention provide methods and systems useful for dynamic foveation of virtual content to implement image compression and reduce storage requirements. The invention is applicable to a variety of applications in computer vision and image display systems.

In some video systems, the incoming video frame rate is lower than the eye-tracking frame rate. For instance, the video frame rate can be 60 Hz, but the eye tracking system can generate eye gaze information at 120 Hz. In the context of these systems, embodiments of the present invention provide a dynamically varying window size for the foveated region. In some embodiments, the window size is directly proportional to the current speed of the eye movement. Thus, embodiments of the present invention are able to maintain a reduced un-foveated window size (e.g., the smallest possible un-foveated window size). Receiving incoming video frames at a first rate and eye tracking information at a higher, second rate, the system described herein dynamically sizes the foveation window based on the eye gaze location and/or velocity to reduce the foveation window size and data processing and memory resource utilization as a result.

It should be noted that utilizing embodiments of the present invention, not only can the foveation window size be varied dynamically, but the eye tracking sample rate can be varied as well. For example, the size of the window could be increased and the eye tracking sampling rate could be decreased to 60 Hz. As a result, embodiments of the present invention provide benefits over conventional systems since eye tracking consumes power, which can be reduced by the dynamic variation of the foveation window size and/or the eye tracking sampling rate.

Some embodiments of the present invention utilize dynamic foveation based on user eye gaze to decrease memory access and data transmission requirements. In particular, embodiments provide eye gaze information to a foveation process in order to define a foveation aperture based on eye gaze position and/or velocity. Therefore, embodiments of the present invention are able to utilize individual compression quality settings for different portions of an image, which provides benefits not available using methods in which the whole image has a single compression quality setting.

Embodiments of the present invention are explained in relation to foveation of images, but are applicable to a variety of encoding standards, including JPEG and MPEG compression standards and/or sub-sampling of the image. In particular, embodiments of the present invention are applicable to image and video compression operations in which the quality setting is variable across the image. As described more fully herein, utilizing the methods and systems discussed herein, different portions of an image can be selected based on the eye gaze and subsequently compressed using different quality settings, with portions of the image adjacent to the location of the eye gaze being compressed with a higher quality setting and portions of the image more distant from the location of the eye gaze being compressed with a lower quality setting, thereby enabling reductions in the amount of data that is stored, transmitted, and the like. Since the user is looking at the eye gaze location, the more lossy compression utilized with portions of the image more distant from the eye gaze location has a reduced impact on user experience while reducing processing and memory requirements.

Numerous benefits are achieved by way of the present invention over conventional techniques. For example, embodiments of the present invention provide methods and systems that reduce memory access to double data rate synchronous dynamic random access memory (DDR SDRAM) and internal integrated chip (IC) data movement, thereby reducing power consumption when moving display data and when processing video. Additionally, embodiments of the present invention reduce the amount of memory that is needed for storage. These and other embodiments of the invention along with many of its advantages and features are described in more detail in conjunction with the text below and attached figures.

### BRIEF DESCRIPTION OF THE DRAWINGS

FIG. 1 illustrates a user's view of augmented reality (AR) through an AR device.

FIG. 2 is a simplified diagram illustrating the size of the high resolution area corresponding to a human eye.

FIG. 3A is a simplified schematic diagram illustrating a foveated image according to an embodiment of the present invention.

FIG. 3B is a simplified schematic diagram illustrating a foveated image according to another embodiment of the present invention.

FIG. 4 is a simplified schematic diagram illustrating a gaze-based foveation system according to an embodiment of the present invention.

FIGS. 5A and 5B show a simplified flowchart illustrating methods of foveating virtual content according to an embodiment of the present invention.

FIG. 6A is a simplified pixel diagram for a display screen including four tiled regions according to an embodiment of the present invention.

FIG. 6B is a simplified pixel diagram for a display screen including four overlapping regions according to an embodiment of the present invention.

FIG. 6C is a simplified pixel diagram for a display screen including a central region according to an embodiment of the present invention.

FIG. 7 is a simplified flowchart illustrating a method of foveating images based on gaze velocity according to an embodiment of the present invention.

FIG. 8 is a simplified flowchart illustrating a method of foveating images based on eye gaze information according to an embodiment of the present invention.

FIG. 9 is a simplified flowchart illustrating a method of forming a foveated image according to an embodiment of the present invention.

FIG. 10A is a simplified system schematic showing system operation for a first use case according to an embodiment of the present invention.

FIG. 10B is a simplified system schematic showing system operation for a second use case according to an embodiment of the present invention.

FIG. 10C is a simplified system schematic showing system operation for a third use case according to an embodiment of the present invention.

FIG. 10D is a simplified system schematic showing system operation for a fourth use case according to an embodiment of the present invention.

FIG. 10E is a simplified system schematic showing system operation for a fifth use case according to an embodiment of the present invention.

FIG. 11 illustrates a simplified computer system according to an embodiment of the present invention.

FIG. 12A illustrates a cross-sectional, side view of an example of a set of stacked waveguides that each includes an incoupling optical element.

FIG. 12B illustrates a perspective view of an example of one or more stacked waveguides of FIG. 12A.

FIG. 12C illustrates a top-down, plan view of an example of one or more stacked waveguides of FIGS. 12A and 12B.

FIG. 13 is a simplified illustration of an eyepiece waveguide having a combined pupil expander.

FIG. 14 illustrates an example of a wearable display system.

FIG. 15 shows a perspective view of a wearable device.

### DETAILED DESCRIPTION OF SPECIFIC EMBODIMENTS

The present invention relates generally to methods and systems related to projection display systems including wearable displays. More particularly, embodiments of the present invention provide methods and systems that combine the concept of foveation (i.e., reduced video quality at sections where the human eye is not focused) with eye gaze information in order to implement compression of virtual content. The invention is applicable to a variety of applications in computer vision and image display systems and light field projection systems, including stereoscopic systems, systems that deliver beamlets of light to the retina of the user, or the like.

In conventional systems, MPEG compression is implemented at a fixed quality that does not take into account the human gaze. By knowing where the human gaze is currently located and taking the human gaze into account, embodiments of the present invention can reduce the quality (i.e., the bandwidth) at locations in an image where the user is not looking, i.e., locations in the image that are spatially separated from the eye gaze location, thereby decreasing the image quality in these regions and decreasing the overall need to send something at a superior quality setting that the human eye would not be able to discern, because the human eye is not currently focused on these non-gaze locations. Thus, embodiments of the present invention provide a video compression algorithm that takes human gaze into account and creates a foveated compression algorithm dependent on human gaze.

Foveation is performed by having a region of an image with high quality while the rest of the image is at a reduced quality. The high quality region can be referred to as a primary quality region and the rest of the image, i.e., the low quality region, can be referred to as a secondary quality region.

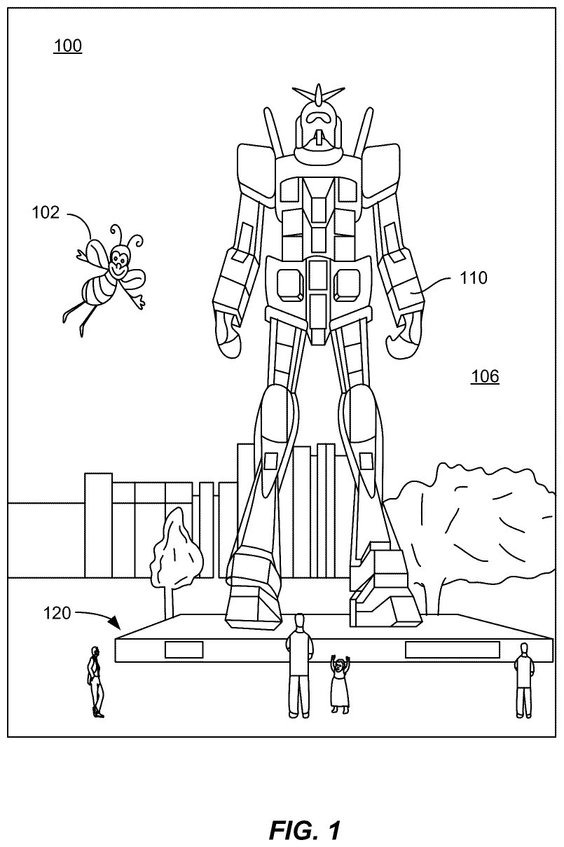

FIG. 1 illustrates a user's view of augmented reality (AR) through an AR device. Embodiments of the present invention are applicable to virtual content produced for display in such an AR device. Referring to FIG. 1, an augmented reality scene 100 is depicted wherein a user of an AR technology sees a real-world park-like setting 106 featuring people, trees, buildings in the background, and a concrete platform 120. In addition to these items, the user of the AR technology also perceives that he “sees” a robot statue (110) standing upon the real-world platform (120), and a cartoon-like avatar character (102) flying by, which seems to be a personification of a bumble bee, even though these elements (102, 110) do not exist in the real world. Due to the extreme complexity of the human visual perception and nervous system, it is challenging to produce a VR or AR technology that facilitates a comfortable, natural-feeling, rich presentation of virtual image elements amongst other virtual or real-world imagery elements.

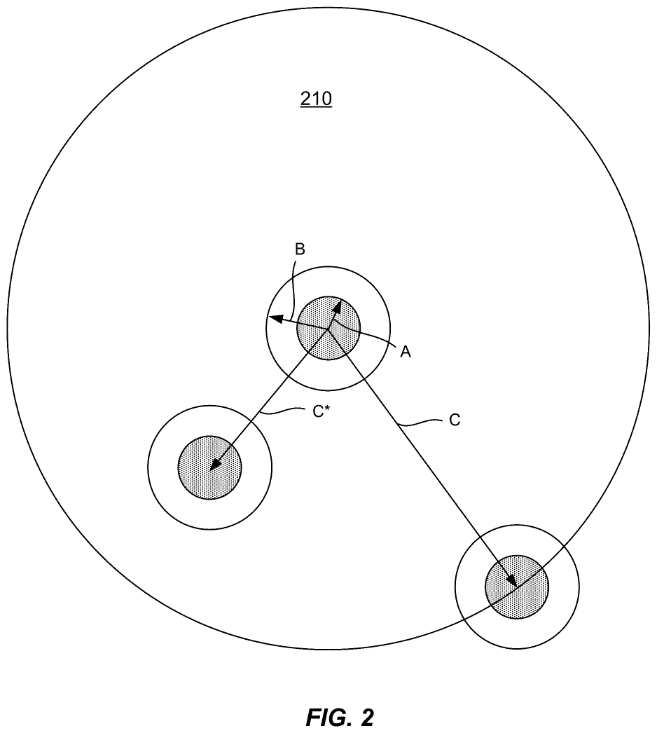

FIG. 2 is a simplified diagram illustrating the size of the high resolution area 210 corresponding to a human eye. As illustrated in FIG. 2 and Table 1 below, the eye only has about a 4° radius region of high quality (radius A). Adding some overhead for compute noise, the area of high quality can be considered as radius B. If the rate of eye tracking occurs at 60 Hz, this means that the eye will be able to move during a time period of 16 ms ( 1/60 Hz) before the next eye tracking measurement is made. Given that the eyeball can move at about 700° to 1,000° per second (Distance C), this means that the eye could move an additional 12° radius during this time. Thus, the total region of high quality that corresponds to the eye illustrated by the high resolution area with radius A in FIG. 2 is in the range of a diameter of 34° assuming these parameters. This range of a diameter of 34° can be converted to pixel dimensions (e.g., X by Y pixels) based on screen resolution (i.e., pixels per degree of the display device).

TABLE 1

| Parameter | Value |
|---|---|
| Eye tracking frame rate | 120 Hz |
| Maximum eye saccade radius (C) | 6° |
| High quality radius (A) | 4° |
| Eye tracking compute noise radius (B) | 1° |
| Total foveation diameter | 22° |

If the eye tracking rate is increased to 120 Hz, the diameter of the high resolution can be significantly reduced, for example, to 22° (i.e., [A=4°+B=1°+C*=6° ]*2, where C* is the measured eye saccade distance). As will be evident to one of skill in the art, the size of the high quality region directly correlates with the amount of high quality imaging that is needed. Thus, the smaller the diameter of the high quality region is, the smaller the amount of high quality memory that will be utilized.

In some AR systems, the incoming display data for the display device can be a first range, e.g., 60 Hz. Regardless of the eye tracking rate, if the system preemptively destroys the high quality region that is needed for the subsequent 1/120 Hz frame (for example, using a narrow window 1/120 Hz high quality box with a diameter of 22°), the system will not have the necessary information to complete processing of that subsequent image. Accordingly, the system would maintain a high quality region corresponding to 60 Hz eye tracking (namely, 34°).

To solve this problem, embodiments of the invention maintain a reduced size (e.g., the smallest possible) high accuracy region, and control the size of the high quality region based on the measured velocity/acceleration of the eyeball. Although this may potentially result in one frame in which incomplete image information is present, once the eye tracking system detects that the eye is moving at a high rate of speed, the aperture of high quality can be increased to a larger setting. Once the eyeball slows down, the size of the aperture can be narrowed once again in a dynamic manner. Moreover, if the system maintains a “low quality” image for which the quality is normally indistinguishable from a high quality image, for instance, a JPEG quality of 90%, the user will not notice that one frame of missed aperture size is present in the display data.

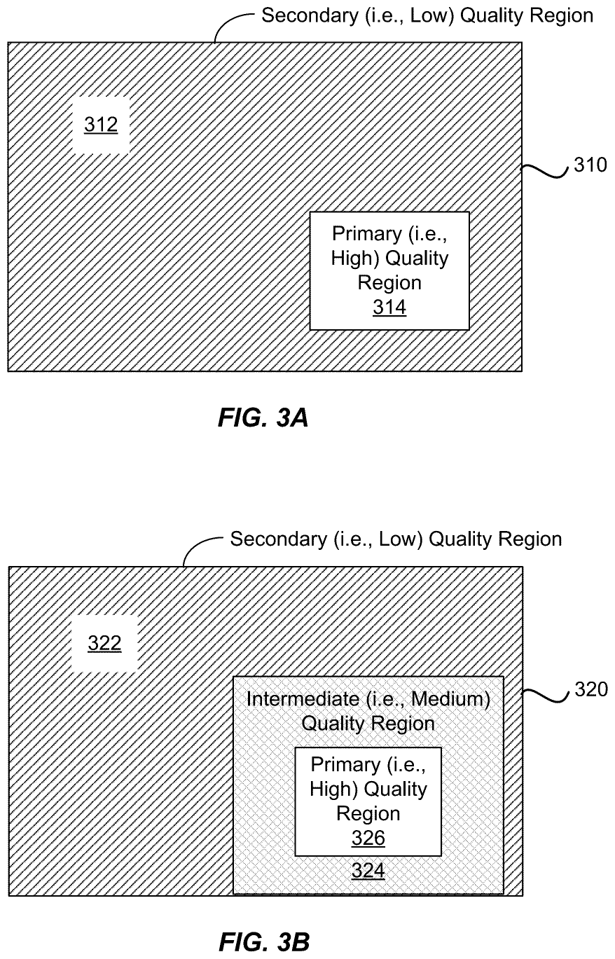

FIG. 3A is a simplified schematic diagram illustrating a foveated image according to an embodiment of the present invention. In FIG. 3A, a foveated image 310 is illustrated that includes a primary quality region 314 (also referred to as a high quality region), for example, compressed using a first quality factor, and a secondary quality region 312 (i.e., the remainder of foveated image 310, which can be referred to as a secondary quality region), for example, compressed using a second quality factor less than the first quality factor. The foveated image utilizes reduced memory and processing in comparison with an image of the same size that was compressed using the first quality factor.

FIG. 3B is a simplified schematic diagram illustrating a foveated image according to another embodiment of the present invention. Similar to the foveated image 310 illustrated in FIG. 3A, foveated image 320 includes a primary quality region 326 (also referred to as a high quality region), for example, compressed using a first quality factor, and a secondary quality region 322 (also referred to as a low quality region), for example, compressed using a second quality factor less than the first quality factor, but also includes an intermediate quality region (also referred to as a medium quality region), for example, compressed with a third quality factor between the first quality factor and the second quality factor. Thus, although some embodiments are discussed in relation to foveated images with two regions, i.e., a high quality region and a low quality region, embodiments of the present invention are not limited to this two region implementation and more than two quality levels can be used, for example, three quality levels as illustrated in FIG. 3B or more than three quality levels. One of ordinary skill in the art would recognize many variations, modifications, and alternatives.

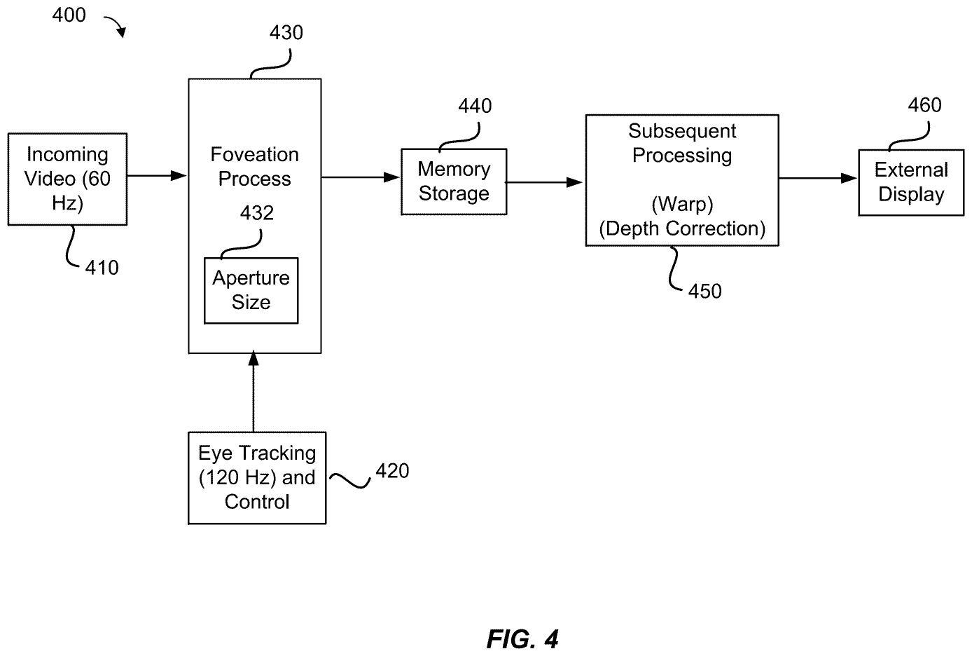

FIG. 4 is a simplified schematic diagram illustrating a gaze-based foveation system according to an embodiment of the present invention. The system 400 receives incoming video 410, for example, virtual content for display on an AR device, at a first frame rate, illustrated as 60 Hz in FIG. 4. Additionally, eye tracking and control information 420 is received at a second frame rate, illustrated as 120 Hz in FIG. 4. These inputs are utilized by a foveation process 430 to foveate the incoming video, with a high quality region (i.e., a central region) defined by aperture size 432. As an example, the high quality region can be a rectangle with the smaller dimension of the rectangle (i.e., the height) equal to 22°. As described more fully herein, the aperture size 432 can be controlled dynamically based on the value of the measured eye saccade radius C* shown in FIG. 2. The remainder of the image can be compressed using a lower quality setting. The high quality region can be referred to interchangeably as a primary quality region and the low quality region can be referred to interchangeably as a secondary quality region.

The foveated image produced by the foveation process 430 can be stored in memory and subsequent processing including warp and depth correction can be performed by subsequent processing process 450 prior to displaying the foveated image on an external display 460. In some embodiments, the high quality region corresponding to the aperture size 432 (i.e., the central region) and the remainder of the image (i.e., the peripheral region) are produced and processed/saved as different streams, whereas, in other embodiments, a single stream is utilized. One of ordinary skill in the art would recognize many variations, modifications, and alternatives.

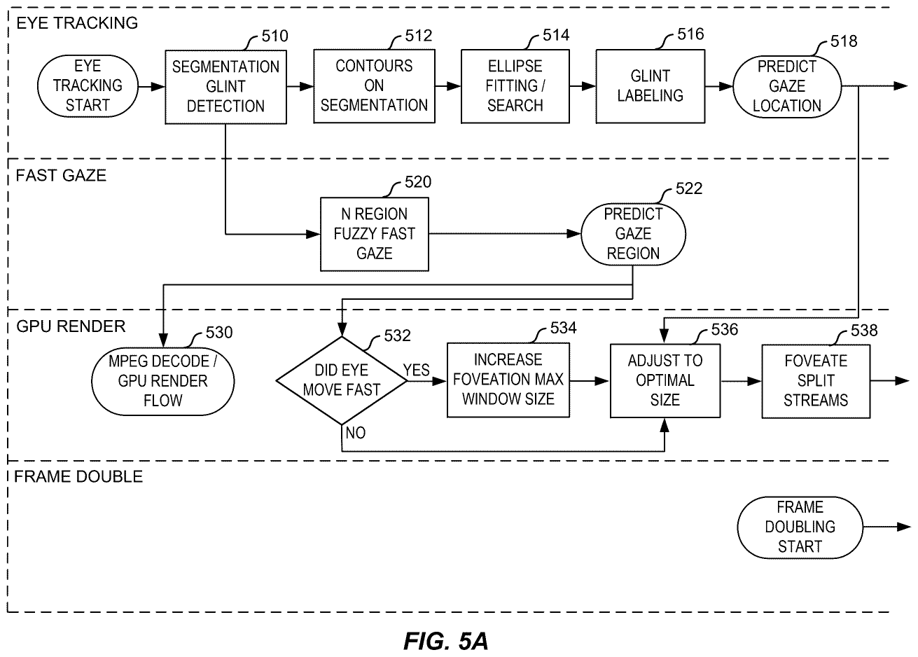

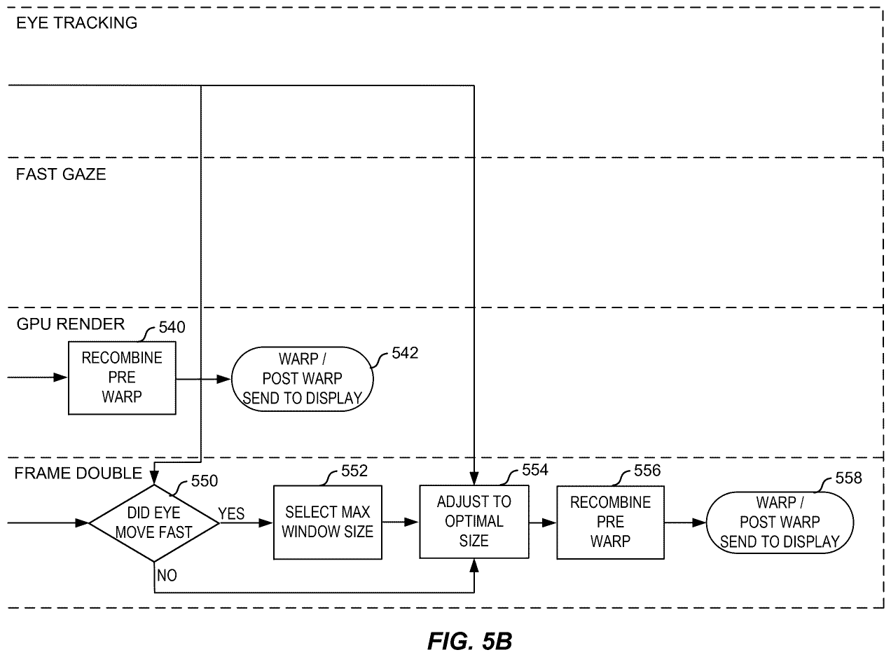

FIGS. 5A and 5B show a simplified flowchart illustrating methods of foveating virtual content according to an embodiment of the present invention. The flow illustrated as starting in FIG. 5A continues to FIG. 5B. As illustrated in the first row of FIG. 5A, an eye tracking process is illustrated. The eye tracking process, which can be referred to as a full eye gaze determination or prediction process, can include a segmentation and glint detection process 510, determining contours on the segmentation 512, ellipse fitting/search 514, glint labeling 516, and eye gaze location prediction 518. This eye gaze location (and velocity determined, for example, based on frame-to-frame location, as well as acceleration in some embodiments) can then be provided to multiple processes, including a GPU rendering process and a frame doubling process. Although this particular method of determining eye gaze location and velocity is illustrated, embodiments of the present invention are not limited to this particular eye gaze location/velocity process and other eye gaze location/velocity processes can be utilized within the scope of the present invention.

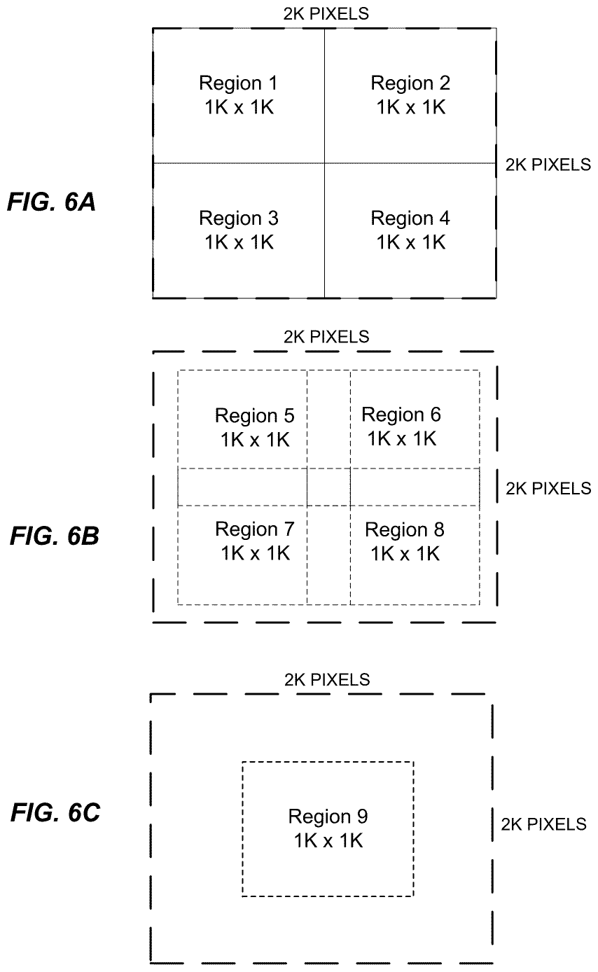

Referring to the second row in FIG. 5A, a fast gaze process is illustrated. The fast gaze process, which can be described in conjunction with the nine regions shown in FIGS. 6A-6C below, can receive information from an initial stage of the eye tracking process, for instance, the initial eye gaze location determined after the segmentation and glint detection process 510. Although the accuracy of the segmentation and glint detection information can be low, this information can provide a prediction of which region of a display corresponds to the user's eye gaze.

FIG. 6A is a simplified pixel diagram for a display screen including four tiled regions according to an embodiment of the present invention. The four tiled regions shown in FIG. 6A, i.e., Region 1, Region 2, Region 3, and Region 4, are contiguous 1K×1K regions that, together, fill the 2K×2K display. These four regions correspond to the eye gaze being in the top left quadrant of the 2K×2K display (i.e., Region 1), the eye gaze being in the top right quadrant of the 2K×2K display (i.e., Region 2), the eye gaze being in the bottom left quadrant of the 2K×2K display (i.e., Region 3), or the eye gaze being in the bottom right quadrant of the 2K×2K display (i.e., Region 1). The region in which the eye gaze location is located can be referred to as the eye gaze region.

FIG. 6B is a simplified pixel diagram for a display screen including four overlapping regions according to an embodiment of the present invention. The four overlapping tiled regions shown in FIG. 6B, i.e., Region 5, Region 6, Region 7, and Region 8, are 1K×1K regions. These four regions correspond to the eye gaze being in or between the top left quadrant and substantially the center of the 2K×2K display (i.e., Region 5), the eye gaze being in or between the top right quadrant and substantially the center of the 2K×2K display (i.e., Region 6), the eye gaze being in or between the bottom left quadrant and substantially the center of the 2K×2K display (i.e., Region 7), or the eye gaze being in or between the bottom right quadrant and substantially the center of the 2K×2K display (i.e., Region 8). Thus, each of these regions overlaps with each of the other regions, with all four regions overlapping at the center of the 2K×2K display.

FIG. 6C is a simplified pixel diagram for a display screen including a central region according to an embodiment of the present invention. Region 9 is a 1K×1K region centered at the center of the 2K×2K display. It should be noted that the nine regions illustrated in FIGS. 6A-6C are large compared to the region of high quality (radius A) shown in FIG. 2. In the example of 1K×1K regions, each region can cover a 32°×32° area, which is large compared to a region of high quality covering a 4°×4° area.

In combination, FIGS. 5A and 6A-6C illustrate a process referred to as fast gaze, which can be a component of the dynamic foveation methods and systems discussed herein. In the fast gaze process, information from the segmentation and glint detection process 510 is utilized by a neural network illustrated by N region fuzzy fast gaze process 520, for example, a deep network or any available information from computer vision algorithms, that has been trained to predict the gaze region before the eye gaze location prediction 518 is available from the eye tracking process illustrated in FIG. 5A. The gaze region prediction 522 produced by the fast gaze process is the region (e.g., out of nine regions in this embodiment) corresponding to the estimated eye gaze location.

Referring to FIGS. 6A-6C, as the eye gaze location moves, for example, from the top left of the 2K×2K display toward the bottom right of the 2K×2K display, the region corresponding to the eye gaze location will shift from Region 1 to Region 5 to Region 9 to Region 8 to Region 4. Although the eye gaze location estimate based on the segmentation and glint detection process 510 is only approximate, particularly in comparison to the eye gaze location prediction 518 produced by the eye tracking process illustrated in the first row of FIG. 5A, this eye gaze location estimate can be accurate enough to correctly locate the eye gaze location within one of the nine regions illustrated in FIGS. 6A-6C, represented by gaze region prediction 522. As will be evident to one of skill in the art, as the aperture size 432 shown in FIG. 4 decreases in size, more accurate eye gaze location predictions are utilized. However, as the aperture size increases, for example, to the 1K×1K regions illustrated in FIGS. 6A-6C, less accuracy is needed in relation to the eye gaze location prediction. As a result, the segmentation and glint detection information can be used to provide the relatively low accuracy results produced by the gaze region prediction 522.

In operation, when the eye tracking system detects that the eye is moving at a rate above the threshold velocity, the system dynamically switches to the larger non-foveated window size (i.e., the maximum foveation window size) and the “fast gaze” information is utilized to select the region that is kept as non-foveated. This is done with the intention of a subsequent correction to the actual central region location once a better eye position is calculated. Since the window size can be increased dramatically upon a fast eye movement (e.g., to about 32° of width given that only ~4° is needed for clarity), the system will provide a substantial guard-band to allow for a fuzzy, nine large-quadrant selection mechanism. One of the nine possible quadrants, illustrated by the four quadrants in FIG. 6A, the four regions in FIG. 6B, and the central region in FIG. 6C, is thus identified as the gaze region prediction 522 output by the fast gaze process. In addition to variation of the foveation window size, as discussed above, embodiments of the present invention can also vary the eye tracking sampling rate, either in place of variation of the foveation window size or in addition to variation of the foveation window size.

In FIGS. 6A-6C, the images are illustrated as 2K×2K images. However, this image size is not required and the image size can be scaled up or scaled down based on different display resolution and/or a different field of view configuration as well. Moreover, although FIG. 5A illustrates gaze region prediction 522 at a point in time, the past position and velocity of the eye gaze can be utilized in order to output the gaze region prediction 522. One of ordinary skill in the art would recognize many variations, modifications, and alternatives.

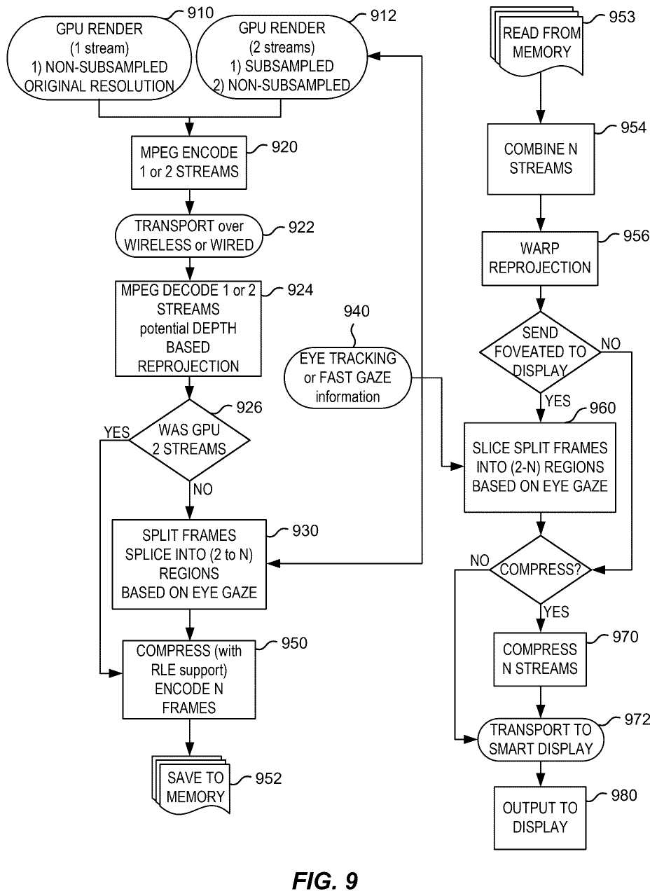

The GPU render process, which is illustrated in the third row of FIGS. 5A and 5B, can share common elements with the process shown in FIG. 9 below. The GPU render process can receive the predicted gaze region and utilize different flows (530) depending on the eye gaze velocity. If the eye is moving faster than a threshold (532), then the foveation window size can be increased to the maximum foveation window size (534). If the eye is moving slower than the threshold, the foveation window can be adjusted to an optimal size based on the eye gaze velocity (536). As the accuracy of the gaze region prediction 522 (i.e., the eye gaze location prediction) increases, the foveation window size can be decreased, thereby reducing processing and memory utilization. As an example, referring to FIG. 2 and Table 1, the smaller dimension (i.e., the height) of the aperture size rectangle can be set to A+B+C*, increasing and decreasing in size in a dynamic manner as the measured eye saccade velocity C* varies as a function of time. In other embodiments, the eye tracking sampling rate can be decreased (or increased) in addition to or in place of decreases in the foveation window size. As a result, embodiments of the present invention produce a foveated region that can be reduced in size, but not be visually apparent to the user. As discussed herein, one missed frame will not be noticeable to a user. Additionally, the eye tracking sampling rate can be increased as appropriate to the particular application.

The split streams are foveated (538) and later recombined (540) as illustrated in FIG. 5B. The recombined image is pre-warped and sent to the display once the warp/post-warp processing is completed (542).

The frame doubling process, which is illustrated in the fourth row of FIGS. 5A and 5B, enables video content received at a first frame rate (e.g., 60 Hz) to be rendered and displayed at a second frame rate (e.g., 120 Hz). Because the first frame rate is lower than the second frame rate, embodiments of the present invention utilize foveation based on the eye gaze location to compensate for this frame rate difference. As an example, if an image from video content received at 60 Hz is foveated for display at 120 Hz, the foveation is performed by embodiments of the present invention in a way that ensures that the aperture size used for foveation is large enough to include the eye gaze location for both 120 Hz images produced based on the received 60 Hz image. Thus, the frame doubled images will include high quality content corresponding to the eye gaze location at the time both 120 Hz frame double images are displayed.

Referring to FIG. 5B, a determination is made of whether the eye is moving faster than a threshold (550). If so, then the foveation window size can be increased to the maximum foveation window size (552). This ensures that the high quality region of the foveated image (i.e., the primary quality region) is large enough to include high resolution content during the next frame doubled image. If the eye is moving slower than the threshold, the foveation window can be adjusted to an optimal size based on the eye gaze velocity (554). The split streams are foveated and the streams are recombined (556) as illustrated in FIG. 5B. The recombined image is pre-warped and sent to the display once the warp/post-warp processing is completed (558).

The frame doubling process illustrated in FIG. 5B provides a number of benefits in comparison with conventional techniques. As an example, the eye tracking rate can be decreased. Additionally, the render/display rate can be increased with respect to the GPU rendering rate, thereby decreasing GPU processing requirements.

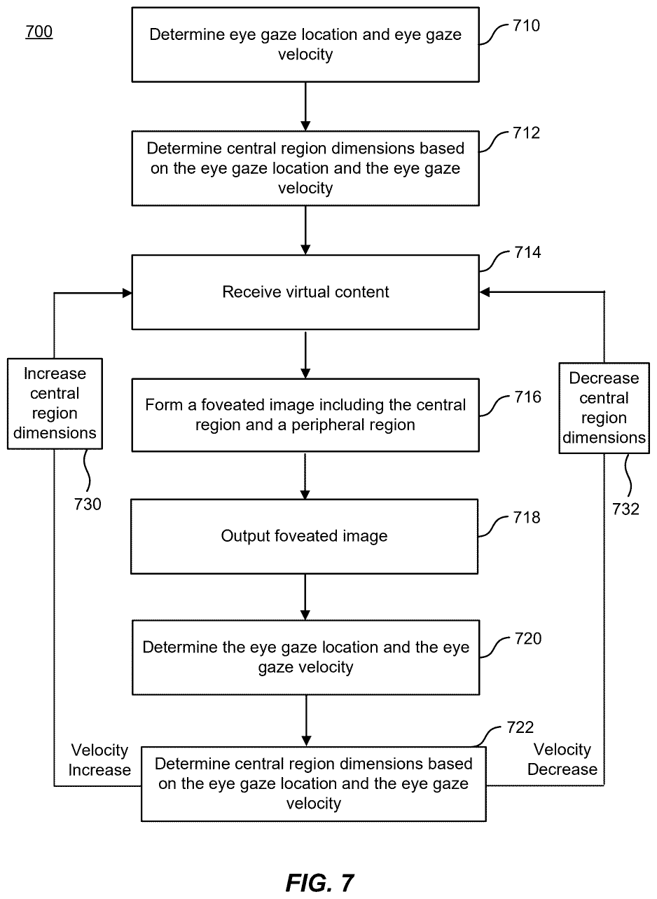

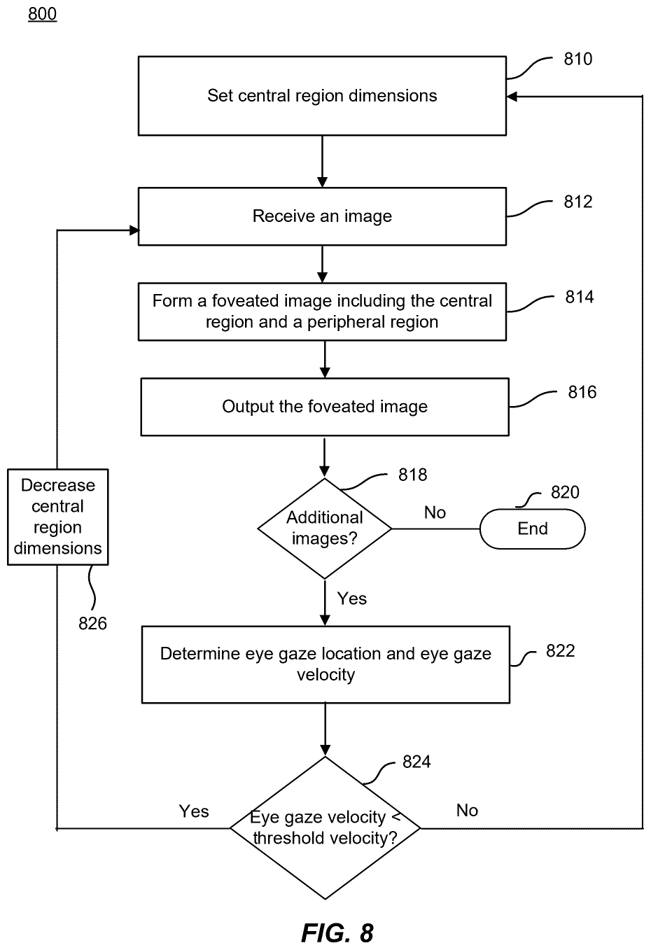

FIG. 7 is a simplified flowchart illustrating a method of foveating images based on gaze velocity according to an embodiment of the present invention. As illustrated in FIG. 7, the method 700 includes determining eye gaze location and eye gaze velocity (710). In some embodiments, the eye gaze acceleration is also determined. Given the eye gaze location and eye gaze velocity, the central region dimensions are determined (712). The central region dimensions can be the foveation window size at which high quality content is presented, i.e., the 4° radius region of high quality (radius A in FIG. 2). The remainder of the image will be compressed with a lower quality setting in order to reduce memory and processing utilization.

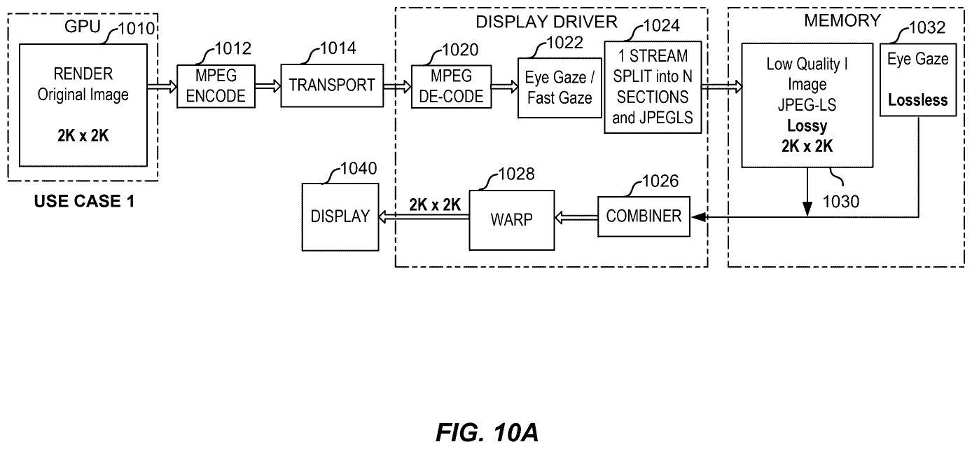

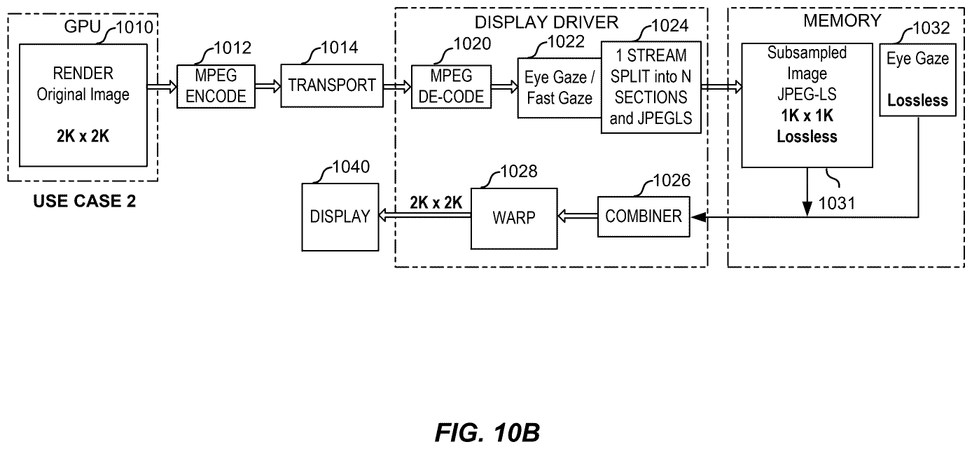

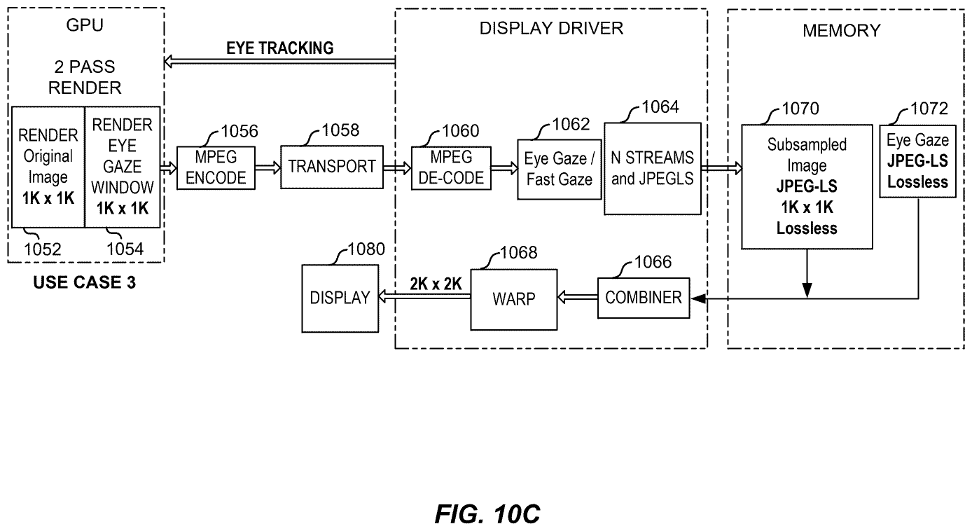

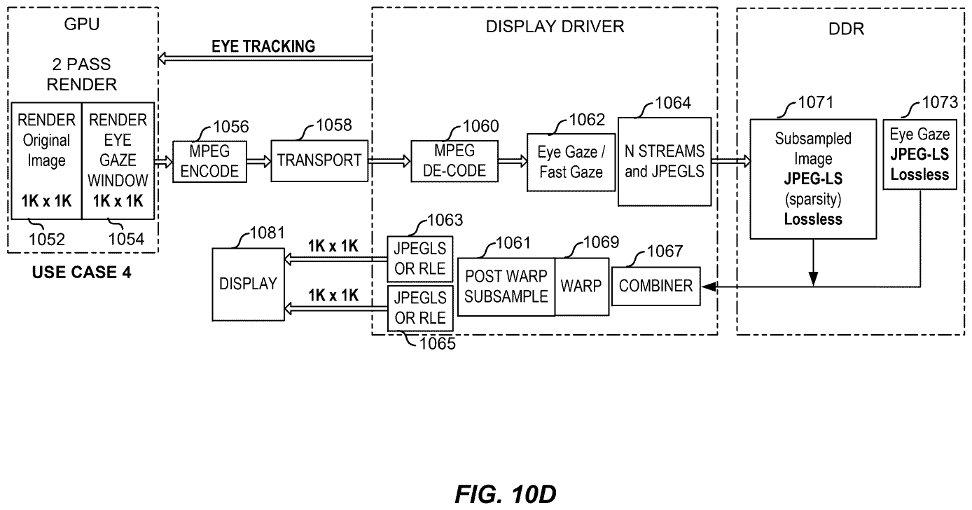

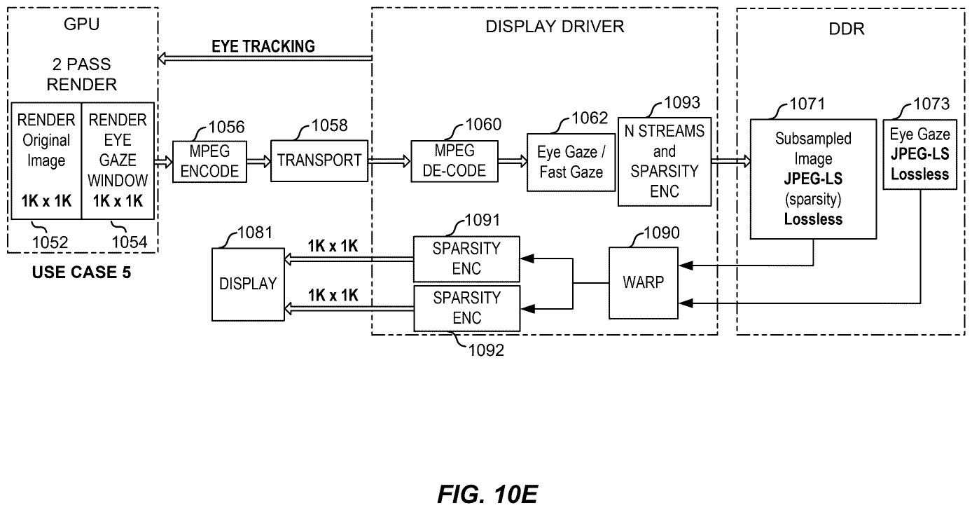

The method also includes receiving virtual content (714) and forming a foveated image including the central region and a peripheral region (716). The central region can be compressed using a first quality factor and the peripheral region can be compressed using a second quality factor less than the first quality factor. As discussed in relation to FIG. 10E, embodiments of the present invention provide the ability to utilize two streams from the GPU to the display, which can implement a low overhead method to merge both streams. In some embodiments, the central region and the peripheral region are produced and processed/saved as different streams, whereas in other embodiments, a single stream is utilized. One of ordinary skill in the art would recognize many variations, modifications, and alternatives. The foveated image is output for display (718).

The eye tracking system is then utilized to determine the eye gaze location and the eye gaze velocity (720) and the central region dimensions are determined based on the eye gaze location and the eye gaze velocity (722). If the eye gaze velocity has decreased from the previously determined eye gaze velocity (step 710), then the central region dimensions are increased (730) and the method returns to step 714. If the eye gaze velocity has increased from the previously determined eye gaze velocity (step 710), then the central region dimensions are decreased (732) and the method returns to step 714. This iterative process is repeated, modifying the central region dimensions based on the eye gaze location and eye gaze velocity. In some embodiments, the eye gaze acceleration is also utilized in conjunction with or in place of the eye gaze location and/or eye gaze velocity.

Thus, embodiments of the present invention form foveated images with the high quality region (i.e., the central region) position and size varying as a function of the eye gaze location and eye gaze velocity. This dynamic adjustment of the position and size of the high quality region enables system operation with reduced memory and processor utilization.

It should be appreciated that the specific steps illustrated in FIG. 7 provide a particular method of foveating images based on gaze velocity according to an embodiment of the present invention. Other sequences of steps may also be performed according to alternative embodiments. For example, alternative embodiments of the present invention may perform the steps outlined above in a different order. Moreover, the individual steps illustrated in FIG. 7 may include multiple sub-steps that may be performed in various sequences as appropriate to the individual step. Furthermore, additional steps may be added or removed depending on the particular applications. One of ordinary skill in the art would recognize many variations, modifications, and alternatives.

FIG. 8 is a simplified flowchart illustrating a method of foveating images based on eye gaze information according to an embodiment of the present invention. The method 800 includes setting central region dimensions (810). The central region dimensions can be the maximum foveation window size at which high quality content is presented, i.e., the 4° (radius) region of high quality (radius A in FIG. 2) plus the overhead for compute noise (radius B) plus the maximum eye saccade distance (radius C in FIG. 2). The central region can be a rectangle with the smaller dimension of the rectangle (i.e., the height of the rectangle) being equal to A+B+C=22° at an eye tracking rate of 120 Hz.

The method includes receiving an image (812), forming a foveated image including the central region and a peripheral region (814), and outputting the foveated image (816). In some embodiments, the central region and the peripheral region, which can be referred to as a first region and a second region, are produced and processed/saved as different streams, whereas, in other embodiments, a single stream is utilized. One of ordinary skill in the art would recognize many variations, modifications, and alternatives. If there are no additional images (818), the method 800 ends (820). If there are additional images (818), the method includes determining the eye gaze location and the eye gaze velocity (822). If the eye gaze velocity is less than a threshold (824), then the central region dimensions are decreased (826) and the method returns to step 812. If, on the other hand, the eye gaze velocity is greater than or equal to the threshold, then the central region dimensions are reset (810). In some cases, the central region dimensions are reset to the maximum central region dimensions.

Thus, if the eye tracking system determines that the eye is moving at a velocity greater than the threshold, within one frame, the foveation window size can be reset to the maximum value, thereby ensuring that subsequent content is presented at high quality within the 4° radius region of high quality (radius A in FIG. 2). As subsequent frames are displayed, the eye tracking system will continue to track the eye position and velocity, reducing the foveation window size in a dynamic manner as the eye velocity decreases, thereby producing a hysteresis effect.

It should be appreciated that the specific steps illustrated in FIG. 8 provide a particular method of foveating images based on eye gaze information according to an embodiment of the present invention. Other sequences of steps may also be performed according to alternative embodiments. For example, alternative embodiments of the present invention may perform the steps outlined above in a different order. Moreover, the individual steps illustrated in FIG. 8 may include multiple sub-steps that may be performed in various sequences as appropriate to the individual step. Furthermore, additional steps may be added or removed depending on the particular applications. One of ordinary skill in the art would recognize many variations, modifications, and alternatives.

FIG. 9 is a simplified flowchart illustrating a method of forming a foveated image according to an embodiment of the present invention. FIG. 9 illustrates two different GPU render processes, i.e., a single stream render process with one non-subsampled image at the original resolution (910) and a dual stream render process with one subsampled image at a reduced resolution and one non-subsampled image at the original resolution (912). The single stream render process and subsequent processing are discussed in relation to FIGS. 10A and 10B, whereas the dual stream render process and subsequent processing are discussed in relation to FIGS. 10C and 10D.

FIG. 10A is a simplified system schematic showing system operation for a first use case according to an embodiment of the present invention. In this first use case, which corresponds to the single stream render process (see 910 in FIG. 9), a single stream process is utilized in which the GPU render process produces a 2K×2K image, i.e., the original image, which can be virtual content. An encoding process (e.g., an MPEG encoding process (920 in FIG. 9)) is utilized to encode the original 2K×2K image, with the encoded image transported to the display driver (922 in FIG. 9). As illustrated in FIG. 9, the encoding process can produce one encoded stream or m>1 encoded streams depending on the number of GPU render process being implemented. The encoded stream(s) can be transported over a communications path, which can be a wired communications path or a wireless communications path.

In the display driver, an MPEG decoding process (924 in FIG. 9) is utilized to decode the stream(s). Additionally, depth based reprojection can be performed in combination with the decoding process. Based on the eye gaze information and/or the fast gaze implementation (940 in FIG. 9), which can be determined using one or more of the eye gaze location processes discussed herein, e.g., as illustrated in FIGS. 5A-5B, the decoded image is split into N sections including a primary quality section (i.e., a high quality section) and N-1 JPEG-LS section(s) (930 in FIG. 9). As illustrated in FIG. 3A, the N sections can be two sections: primary quality region and secondary quality region 312. As illustrated in FIG. 3B, the N sections can be three sections: primary quality region 326, intermediate quality region 324, and secondary quality region 322. Thus, N can be equal to two or more.

The secondary (i.e., low) quality image(s) (i.e., the N-1 JPEG-LS section(s)) are compressed and encoded (950 in FIG. 9) and stored in memory (952 in FIG. 9) along with the primary (i.e., high) quality region, which can be compressed using a lossless compression process. For cases in which N>2, each of the N-1 JPEG-LS sections can be compressed using different image qualities. Although JPEG-LS is utilized in this example for sparsity, other sparsity encoding methods can be utilized within the scope of the present invention. Thus, in addition to JPEG-LS, any additional sparsity encoding methodology can be utilized. One of ordinary skill in the art would recognize many variations, modifications, and alternatives.

In order to display the foveated image, the display driver accesses the secondary (i.e., low) quality image(s) (i.e., the N-1 JPEG-LS section(s)) and the primary (i.e., high) quality region (953 in FIG. 9), and combines these images (954 in FIG. 9) to form the foveated image, which can be warp processed (956 in FIG. 9) before the 2K×2K image is displayed using the external display (980 in FIG. 9). If the foveated display is to be sent to the display, the split frames are spliced into multiple (e.g., 2−N) regions based on the eye gaze information (960), which is provided by the eye tracking or fast gaze system (940). The N streams can be compressed (970), transported to the display (which may be a smart display) (972), and output on the external display (980).

FIG. 10B is a simplified system schematic showing system operation for a second use case according to an embodiment of the present invention. In this second use case, which also corresponds to the single stream render process (see 910 in FIG. 9), the GPU render process produces a 2K×2K image, i.e., the original image, which can be virtual content. MPEG encoding (920 in FIG. 9) is utilized to compress the original 2K×2K image, with the compressed image transported to the display driver (922 in FIG. 9). In the display driver, an MPEG decoding process (924 in FIG. 9) is utilized.

Based on the eye gaze information and/or the fast gaze implementation, the decoded image is split into N sections including a high quality section and N-1 JPEG-LS section(s) that are subsampled (930 in FIG. 9). As an example, the N-1 JPEG-LS section(s) can be subsampled to produce 1K×1K image(s). In general, images of various sizes are utilized according to embodiments of the present invention and these images can be referred to as M×N images with the values of M and N defining the image size. The low quality subsampled image(s) (i.e., the N-1 JPEG-LS 1K×1K section(s)) are compressed (950 in FIG. 9) and stored in memory (952 in FIG. 9) along with the high quality region. Because the low quality images are produced using a subsampling process, both the low quality subsampled image(s) and the high quality image can be compressed using a lossless compression process. In other embodiments, the low quality subsampled image(s) are compressed using a lower image quality than the high quality image.

In order to display the foveated image, the display driver accesses the low quality image(s) (i.e., the N-1 JPEG-LS 1K×1K section(s)) and the high quality region (953 in FIG. 9), upsamples the low quality image(s), and combines these images (954 in FIG. 9) to form the foveated image, which can be warp processed (956 in FIG. 9) before the 2K×2K image is displayed using the external display (980 in FIG. 9).

Returning to FIG. 9, the dual stream render process in which the GPU produces one subsampled image at a reduced resolution and one non-subsampled image at the original resolution is illustrated as 912. This dual stream render process is also illustrated in FIGS. 10C and 10D.

FIG. 10C is a simplified system schematic showing system operation for a third use case according to an embodiment of the present invention. In this third use case, which corresponds to the dual stream render process (see 912 in FIG. 9), the GPU render process is a double pass render process that produces a 1K×1K original image and a 1K×1K high quality region image, i.e., the high quality region including the eye gaze location. Eye tracking information is utilized in rendering the 1K×1K high quality region image, which can also be referred to as an eye gaze window.

MPEG encoding (920 in FIG. 9) is utilized to compress the original 1K×1K image and the 1K×1K eye gaze window, with the compressed images transported to the display driver (922 in FIG. 9). In the display driver, an MPEG decoding process (924 in FIG. 9) is utilized and the decoded images (i.e., the original 1K×1K image and the 1K×1K eye gaze window) are compressed and stored in memory (952 in FIG. 9). Thus, as illustrated in FIG. 10C, the original image (i.e., the subsampled image at 1K×1K resolution) and the high quality region (eye gaze window at 1K×1K resolution) can be compressed using a lossless compression process (see 950 in FIG. 9) and stored in memory (952 in FIG. 9). In other embodiments, the original image can be compressed using a lossy compression process as appropriate. One of ordinary skill in the art would recognize many variations, modifications, and alternatives.

In order to display the foveated image, the display driver accesses the low quality image (i.e., the original 1K×1K image) and the high quality region, and combines these images (954 in FIG. 9) to form the foveated image, which can be warp processed (956 in FIG. 9) before the 2K×2K image is displayed using the external display (980 in FIG. 9).

As illustrated in FIG. 9, this third use case, at the decision point 926, does not split the decoded images into N sections because two streams have already been produced by the GPU.

As a result, the display driver merely decodes the two streams, performs compression, for example, only for sparsity, and passes the compressed images to memory for storage.

FIG. 10D is a simplified system schematic showing system operation for a fourth use case according to an embodiment of the present invention. In this fourth use case, which also corresponds to the dual stream render process (see 912 in FIG. 9), the GPU render process is a double pass render process that produces a 1K×1K original image and a 1K×1K high quality region image, i.e., the high quality region including the eye gaze location. Eye tracking information is utilized in rendering the 1K×1K high quality region image, which can also be referred to as an eye gaze window.

MPEG encoding (920 in FIG. 9) is utilized to compress the original 1K×1K image and the 1K×1K eye gaze window, with the compressed images transported to the display driver (922 in FIG. 9). In the display driver, an MPEG decoding process (924 in FIG. 9) is utilized and the decoded images (i.e., the original 1K×1K image and the 1K×1K eye gaze window) are compressed and stored in memory. Thus, as illustrated in FIG. 10D, the original image (i.e., the subsampled image at 1K×1K resolution) and the high quality region (eye gaze window at 1K×1K resolution) can be compressed using a lossless compression process (950 in FIG. 9) and stored in memory (952 in FIG. 9).

In order to display the foveated image, the display driver accesses the low quality image (i.e., the original 1K×1K image) and the high quality region, and performs warp processing and post warp subsampling. JPEG-LS or run length encoding (RLE) processes are utilized to produce two 1K×1K images that are then provided to the external display. In this use case, the external display combines the two 1K×1K images to form the foveated image that is displayed.

This fourth use case provides significant benefits as image resolution increases, for example, from 2K×2K to 4K×4K or 8K×8K. As the image resolution increases, the number of Mobile Industry Processor Interface (MIPI) lines increases accordingly. Accordingly, embodiments of the present invention can transmit N streams to the external display (i.e., N-1 low quality streams and 1 high quality stream) that can then upsample (e.g., double) and merge the N streams to form the foveated image. Merely by way of example, to provide an 8K×8K display output, the display driver could generate one 4K×4K stream (e.g., a subsampled version of the original 8K×8K image) and one 1K×1K high quality image. Alternatively, the display driver could generate one 4K×4K stream and one 2K×2K high quality image. In both of these examples, the processing and transmission requirements corresponding to an 8K×8K stream are significantly higher than those corresponding to either one 4K×4K stream and one 1K×1K high quality image or one 4K×4K stream and one 2K×2K high quality image. Moreover, additional compression and decompression processes (e.g., JPEG encoding and decoding) can be utilized at various portions of the data flow to improve system performance. One of ordinary skill in the art would recognize many variations, modifications, and alternatives.

It should be noted that although JPEG, JPEG-LS, and RLE is utilized in some embodiments, this is not required and other sparsity encoding techniques can be utilized in place of or in addition to the illustrated encoding methods. One of ordinary skill in the art would recognize many variations, modifications, and alternatives.

FIG. 10E is a simplified system schematic showing system operation for a fifth use case according to an embodiment of the present invention. The use case illustrated in FIG. 10E shares common elements with the use case illustrated in FIG. 10D and the description provided in relation to FIG. 10D is applicable as appropriate. However, in the use case illustrated in FIG. 10E, a method of performing the last stage of warp processing that saves an additional 50% (or more) on warp compute is provided. Using the embodiment illustrated in FIG. 10E enables even larger resolution images to be utilized during warp processing. Thus, for example, processing requirements for warping a 4K×4K image can be high, however, in this fifth use case, processing requirements can be reduced by 50%, resulting in the methods and systems described herein being able to process 4K×4K images per eye at approximately the power profile of a 2K×2K design.

As discussed in relation to FIG. 10D, the GPU render process is a double pass render process that produces a 1K×1K original image and a 1K×1K high quality region image, i.e., the high quality region including the eye gaze location. Eye tracking information is utilized in rendering the 1K×1K high quality region image, which can also be referred to as an eye gaze window. It should be noted reference is made to a 1K×1K original image, but it will be appreciated that this “original” image can be a subsampled or reduced quality version.

MPEG encoding (920 in FIG. 9) is utilized to compress the original 1K×1K image and the 1K×1K eye gaze window, with the compressed images transported to the display driver (922 in FIG. 9). In the display driver, an MPEG decoding process (924 in FIG. 9) is utilized and the decoded images (i.e., the original 1K×1K image and the 1K×1K eye gaze window) are compressed and stored in memory. In the embodiment illustrated in FIG. 10E, the original image (i.e., subsampled image at 1K×1K resolution) is compressed using a sparsity encoded compression method and the high quality region (eye gaze window at 1K×1K resolution) can also be compressed using a sparsity encoded compression method (950 in FIG. 9) and stored in memory (952 in FIG. 9). It should be noted that an MPEG module is illustrated and discussed herein. It should be noted that image encoding and decoding is usually implemented as a component of a transport system, which can be performed over a long distance (e.g., remote render) or a short distance (e.g., local belt pack unit or mobile device), that is usually implemented as part of a large system on a chip (SOC). Thus, the use of the Display Driver notation is more conceptual since there may be many implementations, for instance, when eye tracking is performed on another chip and that information is passed to the Display Driver, as well MPEG decode, which could occur on another chip as well. One of ordinary skill in the art would recognize many variations, modifications, and alternatives.

In order to display the foveated image, the display driver accesses the low quality image (i.e., the subsampled image) and the high quality region, and performs warp processing and optional post warp subsampling. In a particular embodiment, the low quality image is processed to replace pixel values corresponding to the eye gaze window with (R,G,B) pixel values of (1,1,1) to make the pixels corresponding to the eye gaze window transparent. Thus, after processing, the low quality image includes pixels corresponding to the original 1K×1K image in the low quality region 312 shown in FIG. 3A with pixels corresponding to the high quality region 314 having pixel values of (1,1,1). As a result, in this implementation, the pixel value of (1,1,1) is utilized as the transparent pixel so that pixel values of (0,0,0) can be sparsity compressed. Therefore, for the foveated buffer, pixels corresponding to the cropped hole (i.e., high quality region 314) are replaced with the transparent pixel (1,1,1).

It should be noted that after warp processing, the rectangular shape of the high quality region 314 is no longer rectangular with 900 corners), but has the shape of an altered parallelogram. Thus, embodiments of the present invention pre-fill the high quality region with the transparent pixel so that upon warping, pixels with a pixel value of (1,1,1) correspond to the high quality image, thereby simplifying the merge process since pixel values in the eye gaze window are not altered.

As illustrated in FIG. 10E, both images are warped and sent to the display line per line in a parallel fashion. As a result, the display receives the two streams (i.e., two lines) and merges them into one line that is displayed, using the transparent pixel to merge both lines. Referring to the display, since the display receives two streams: a compressed, foveated low quality region and a cropped, pristine high quality region 314, bandwidth is conserved. In operation, the display receives the subsampled up-samples and merges in the high quality region pixels with the aid of the transparent pixel.

Sparsity encoding processes are utilized to produce two 1K×1K images that are then provided to the external display. In this use case, the external display combines the two 1K×1K images to form the foveated image that is displayed.

As illustrated in FIG. 10E in comparison to FIG. 10D, the fifth use case eliminates the combiner 1067 illustrated in FIG. 10D and receives two streams at the warp processor 1090. As a result, the warp processor warps the foveated and non-foveated streams separately. Thus, the fifth use case renders warp as two separate streams instead of one steam. Thus, instead of warping one full image, the fifth use case warps two reduced images, which saves the warp engine 50% or more on compute. As will be evident to one of skill in the art, using this implementation, savings can also be experienced on all compute processes from the GPU up to and including the display endpoint.

As an example, instead of warping one 2K×2K image, the fifth use case would warp two 1K×1K images, one a subsampled (i.e., foveated) image and the other a pristine original quality image (tracked by the eye gaze location). Since the size of the foveation window can be varied dynamically, this method reduces the amount of compute used for WARP by 50% or more and enables starting foveation at the GPU and carrying it all the way through WARP and to the display.

Additionally, the subsampling after warp is not needed because one of the images has already been subsampled. The use of the dual pass warp process provides significant savings.

Additionally, replacing the JPEG-LS encoding process utilized in the fourth use case with the sparsity encoding process reduces power, decreases latency, and is an overall improvement to the system.

Referring once again to FIG. 10A, a single stream process is utilized in which the GPU render process 1010 produces a 2K×2K image, i.e., the original image, which can be virtual content. An encoding process (e.g., an MPEG encoding process 1012 is utilized to encode the original 2K×2K image, with the encoded image transported to the display driver 1014.

In the display driver, an MPEG decoding process 1020 is utilized to decode the stream. Based on the eye gaze information and/or the fast gaze implementation 1022, the decoded image is split into N sections including a high quality section and N-1 JPEG-LS section(s) 1024. The N sections can be two sections: a high quality (i.e., first or central) region and low quality (second or peripheral) region or three sections: a high quality region, a medium quality region, and a low quality region.

The low quality image(s) (i.e., the N-1 JPEG-LS section(s)) are compressed and encoded and stored in memory 1030 along with the high quality region, which can be compressed based on the eye gaze using a lossless compression process 1032. In order to display the foveated image, the display driver accesses the low quality image(s) (i.e., the N-1 JPEG-LS section(s)) and the high quality region from memory, and combines these images 1026 to form the foveated image, which can be warp processed 1028 before the 2K×2K image is displayed using the external display 1040.

Referring once again to FIG. 10B, which shares common elements with FIG. 10A, the description provided in relation to FIG. 10A is applicable to FIG. 10B as appropriate. In contrast with the process illustrated in FIG. 10A, the decoded image is split into N sections including a high quality section and N-1 JPEG-LS section(s) that are subsampled 1031. The low quality subsampled image(s) (i.e., the N-1 JPEG-LS 1K×1K section(s)) are compressed and stored in memory along with the high quality region, which can be compressed based on the eye gaze using a lossless compression process 1032. Because the low quality images are produced using a subsampling process, both the low quality subsampled image(s) and the high quality image can be compressed using a lossless compression process.

Referring once again to FIG. 10C, a double pass render process produces a 1K×1K original image 1052 and a 1K×1K high quality region image 1054, i.e., the high quality region including the eye gaze location. Eye tracking information is utilized in rendering the 1K×1K high quality region image 1054, which can also be referred to as an eye gaze window.

MPEG encoding 1056 is utilized to compress the original 1K×1K image and the 1K×1K eye gaze window, with the compressed images transported to the display driver 1058. In the display driver, an MPEG decoding process 1060 is utilized and the decoded images (i.e., the subsampled image at 1K×1K resolution) and the high quality region (eye gaze window at 1K×1K resolution) can be compressed using a lossless compression process and stored in memory (1070 and 1072, respectively). In order to display the foveated image, the display driver accesses the low quality image (i.e., the subsampled image at 1K×1K resolution) and the high quality region (i.e., the eye gaze window at 1K×1K resolution), and combines these images to form the foveated image, which can be warp processed 1068 before the 2K×2K image is displayed using the external display 1080. As shown in FIGS. 10C, 10D, and 10E, some embodiments of the present invention implement use cases in which foveation occurs in the GPU. Eye gaze information is also passed to the main GPU. In these embodiments, the Display Driver module that is shown is also performing eye tracking. It should be noted that in some implementations, this function will be performed by a separate, but equal parallel chip, however for the purposes of clarity, it is assumed that eye tracking is also occurring on the Display Driver module and N streams section will still perform compression on N streams.

Referring once again to FIG. 10D, which shares common elements with FIG. 10C, the description provided in relation to FIG. 10C is applicable to FIG. 10D as appropriate. In contrast with the process illustrated in FIG. 10C, the original image (i.e., the subsampled image at 1K×1K resolution) is compressed using a sparsity encoded compression method 1071 and the high quality region (eye gaze window at 1K×1K resolution) can also be compressed using a sparsity encoded compression method 1073 or a lossless compression process as discussed in relation to lossless compression process 1072.

In order to display the foveated image, the display driver combines the low quality image (i.e., the subsampled image) and the high quality region using combiner 1067 and performs warp processing 1069 and post warp subsampling 1061. After post warp subsampling, two 1K×1K images 1063 and 1065 are produced that are displayed using the external display 1081.

Referring once again to FIG. 10E, which shares common elements with FIG. 10D, the description provided in relation to FIG. 10D is applicable to FIG. 10E as appropriate. In contrast with the fourth use case illustrated in FIG. 10D, the fifth use case illustrated in FIG. 10E utilizes a method of performing the last stage of warp processing that saves an additional 50% (or more) on warp compute is provided.

In the display driver, an MPEG decoding process 1060 is utilized and the original image (i.e., the subsampled image at 1K×1K resolution) is compressed using a sparsity encoded compression method and the high quality region (eye gaze window at 1K×1K resolution) can also be compressed using a sparsity encoded compression method 1093. In order to display the foveated image, the display driver performs warp processing to produce two sparsity encoded images 1091 and 1092. Referring to FIGS. 10D and 10E, different use cases are illustrated, demonstrating that both use cases can be implemented, but not at the same time. Since sparsity compression eliminates the continuity of the data, other forms of compression like JPEG can be easily implemented. In some implementations, logic can be utilized to utilize one of these use cases depending on run time conditions. For example, if the image to be compressed contained a high level of black content and little image data, then a sparsity use case could be implemented. However, if the image to be compressed contained a high level of visual data and little black, i.e., “empty”, content, then a JPEG use case could be implemented. In this latter case, the sparsity use case represented by sparsity encoded compression method 1071 would be replaced with another compression method, for example, a JPEG process. Similar modifications can be made to FIG. 10E as appropriate.

Images 1091 and 1092 are sent to the external display 1081 line per line in a parallel fashion. As a result, the display receives the two streams (i.e., two lines) and merges them into one line that is displayed.

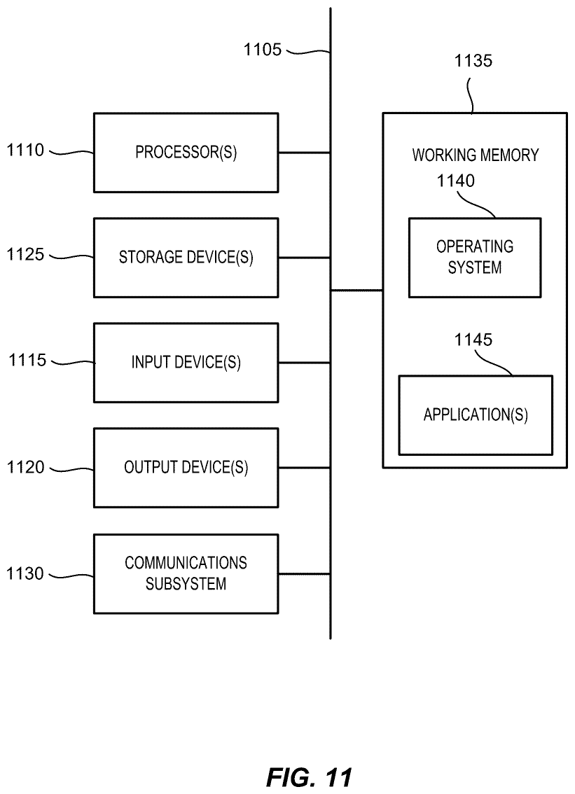

FIG. 11 illustrates a simplified computer system 1100 according to an embodiment of the present invention. Computer system 1100 as illustrated in FIG. 11 may be incorporated into devices described herein. FIG. 11 provides a schematic illustration of one embodiment of computer system 1100 that can perform some or all of the steps of the methods provided by various embodiments. It should be noted that FIG. 11 is meant only to provide a generalized illustration of various components, any or all of which may be utilized as appropriate. FIG. 11, therefore, broadly illustrates how individual system elements may be implemented in a relatively separated or relatively more integrated manner.

Computer system 1100 is shown including hardware elements that can be electrically coupled via a bus 1105, or may otherwise be in communication, as appropriate. The hardware elements may include one or more processor(s) 1110, including without limitation one or more general-purpose processors and/or one or more special-purpose processors such as digital signal processing chips, graphics acceleration processors, and/or the like; one or more input devices 1115, which can include without limitation a mouse, a keyboard, a camera, and/or the like; and one or more output devices 1120, which can include without limitation a display device, a printer, and/or the like.

Computer system 1100 may further include and/or be in communication with the storage device(s) 1125, which can include, without limitation, local and/or network accessible storage, and/or can include, without limitation, a disk drive, a drive array, an optical storage device, a solid-state storage device, such as a random access memory (“RAM”), and/or a read-only memory (“ROM”), which can be programmable, flash-updateable, and/or the like. Such storage devices may be configured to implement any appropriate data stores, including without limitation, various file systems, database structures, and/or the like.

Computer system 1100 might also include a communications subsystem 1130, which can include without limitation a modem, a network card (wireless or wired), an infrared communication device, a wireless communication device, and/or a chipset such as a Bluetooth™ device, an 802.11 device, a WiFi device, a WiMax device, cellular communication facilities, etc., and/or the like. The communications subsystem 1130 may include one or more input and/or output communication interfaces to permit data to be exchanged with a network such as the network described below to name one example, other computer systems, television, and/or any other devices described herein. Depending on the desired functionality and/or other implementation concerns, a portable electronic device or similar device may communicate image and/or other information via the communications subsystem 1130. In other embodiments, a portable electronic device, e.g., the first electronic device, may be incorporated into computer system 1100, e.g., an electronic device as an input device 1115. In some embodiments, computer system 1100 will further include a working memory 1135, which can include a RAM or ROM device, as described above.

Computer system 1100 also can include software elements, shown as being currently located within the working memory 1135, including an operating system 1140, device drivers, executable libraries, and/or other code, such as one or more application programs 1145, which may include computer programs provided by various embodiments, and/or may be designed to implement methods, and/or configure systems, provided by other embodiments, as described herein. Merely by way of example, one or more procedures described with respect to the methods discussed above, might be implemented as code and/or instructions executable by a computer and/or a processor within a computer; in an aspect, then, such code and/or instructions can be used to configure and/or adapt a general purpose computer or other device to perform one or more operations in accordance with the described methods.

A set of these instructions and/or code may be stored on a non-transitory computer-readable storage medium, such as the storage device(s) 1125 described above. In some cases, the storage medium might be incorporated within a computer system, such as computer system 1100. In other embodiments, the storage medium might be separate from a computer system e.g., a removable medium, such as a compact disc, and/or provided in an installation package, such that the storage medium can be used to program, configure, and/or adapt a general purpose computer with the instructions/code stored thereon. These instructions might take the form of executable code, which is executable by computer system 1100 and/or might take the form of source and/or installable code, which, upon compilation and/or installation on computer system e.g., using any of a variety of generally available compilers, installation programs, compression/decompression utilities, etc., then takes the form of executable code.

It will be apparent to those skilled in the art that substantial variations may be made in accordance with specific requirements. For example, customized hardware might also be used, and/or particular elements might be implemented in hardware, software including portable software, such as applets, etc., or both. Further, connection to other computing devices such as network input/output devices may be employed.

As mentioned above, in one aspect, some embodiments may employ a computer system such as computer system 1100 to perform methods in accordance with various embodiments of the technology. According to a set of embodiments, some or all of the procedures of such methods are performed by computer system 1100 in response to processor(s) 1110 executing one or more sequences of one or more instructions, which might be incorporated into the operating system 1140 and/or other code, such as an application program 1145, contained in the working memory 1135. Such instructions may be read into the working memory 1135 from another computer-readable medium, such as one or more of the storage device(s) 1125. Merely by way of example, execution of the sequences of instructions contained in the working memory 1135 might cause the processor(s) 1110 to perform one or more procedures of the methods described herein. Additionally or alternatively, portions of the methods described herein may be executed through specialized hardware.

The terms “machine-readable medium” and “computer-readable medium,” as used herein, refer to any medium that participates in providing data that causes a machine to operate in a specific fashion. In an embodiment implemented using computer system 1100, various computer-readable media might be involved in providing instructions/code to processor(s) 1110 for execution and/or might be used to store and/or carry such instructions/code. In many implementations, a computer-readable medium is a physical and/or tangible storage medium. Such a medium may take the form of a non-volatile media or volatile media. Non-volatile media include, for example, optical and/or magnetic disks, such as the storage device(s) 1125. Volatile media include, without limitation, dynamic memory, such as the working memory 1135.

Common forms of physical and/or tangible computer-readable media include, for example, a floppy disk, a flexible disk, hard disk, magnetic tape, or any other magnetic medium, a CD-ROM, any other optical medium, punchcards, papertape, any other physical medium with patterns of holes, a RAM, a PROM, EPROM, a FLASH-EPROM, any other memory chip or cartridge, or any other medium from which a computer can read instructions and/or code.

Various forms of computer-readable media may be involved in carrying one or more sequences of one or more instructions to the processor(s) 1110 for execution. Merely by way of example, the instructions may initially be carried on a magnetic disk and/or optical disc of a remote computer. A remote computer might load the instructions into its dynamic memory and send the instructions as signals over a transmission medium to be received and/or executed by computer system 1100.

The communications subsystem 1130 and/or components thereof generally will receive signals, and the bus 1105 then might carry the signals and/or the data, instructions, etc. carried by the signals to the working memory 1135, from which the processor(s) 1110 retrieves and executes the instructions. The instructions received by the working memory 1135 may optionally be stored on the storage device(s) 1125, e.g., a non-transitory storage device, either before or after execution by the processor(s) 1110.

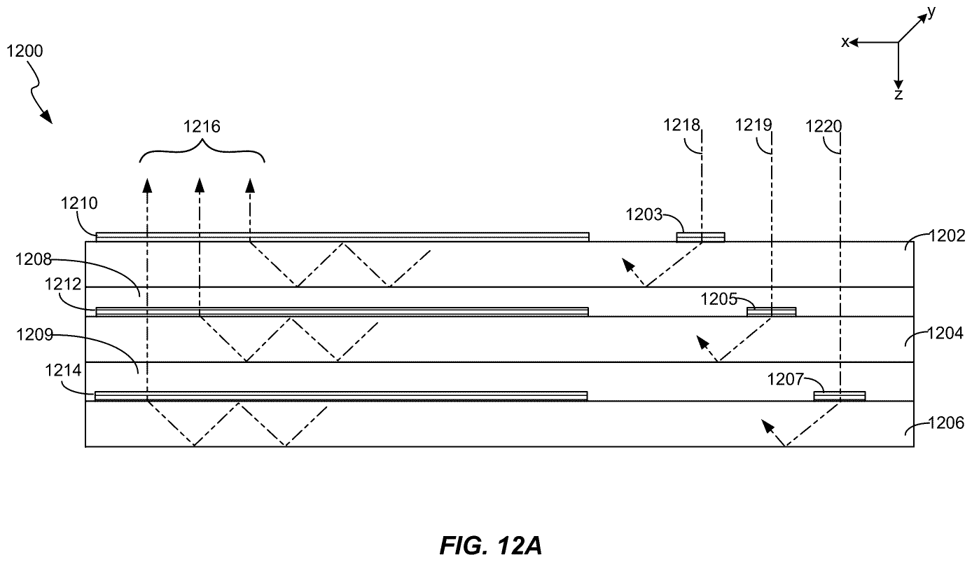

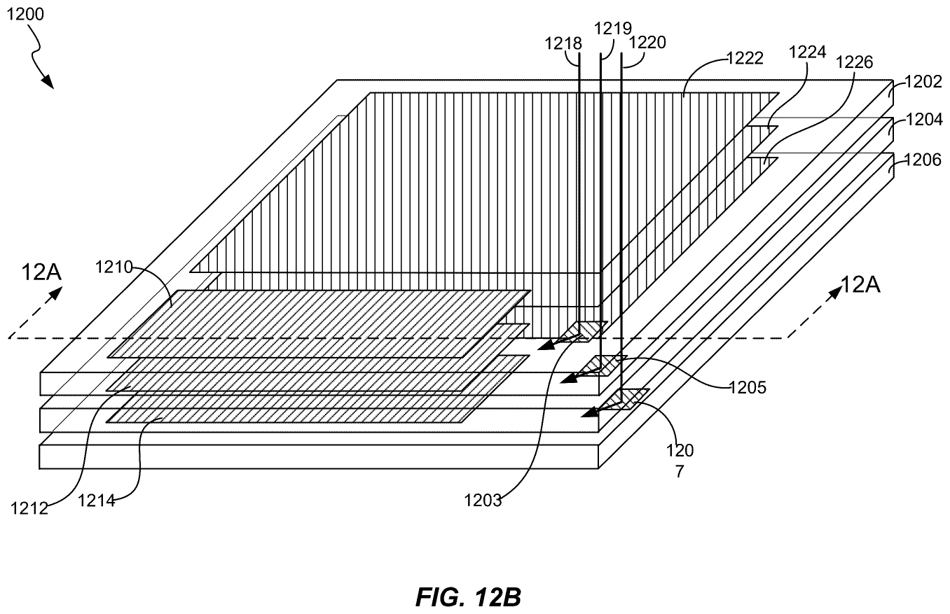

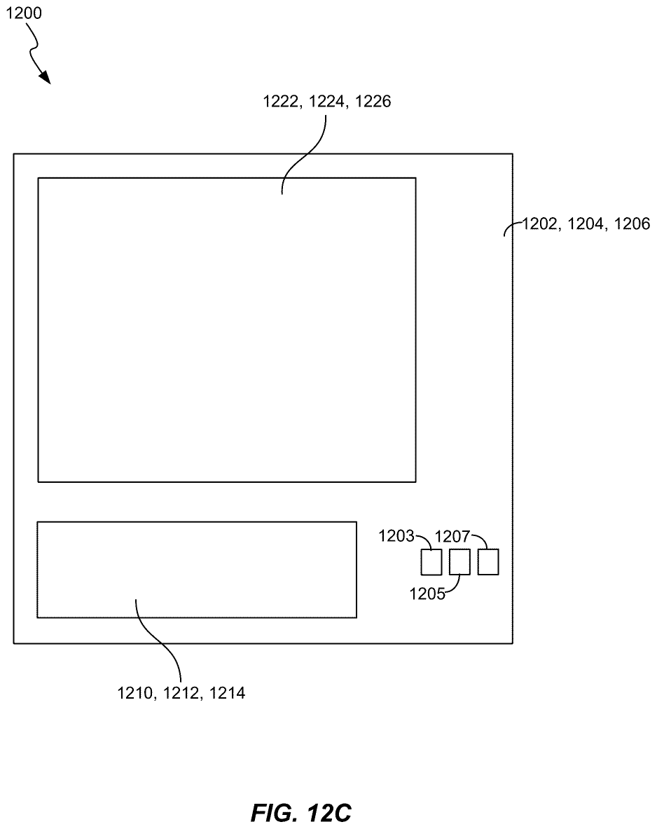

With reference now to FIG. 12A, in some embodiments, light impinging on a waveguide may need to be redirected to incouple that light into the waveguide. An incoupling optical element may be used to redirect and incouple the light into its corresponding waveguide. Although referred to as “incoupling optical element” through the specification, the incoupling optical element need not be an optical element and may be a non-optical element. FIG. 12A illustrates a cross-sectional, side view of an example of a set of stacked waveguides 1200 that each includes an incoupling optical element. The waveguides may each be configured to output light of one or more different wavelengths, or one or more different ranges of wavelengths. Light from a projector is injected into the set of stacked waveguides 1200 and outcoupled to a user as described more fully below.

The illustrated set of stacked waveguides 1200 includes waveguide 1202, waveguide 1204, and waveguide 1206. Each waveguide includes an associated incoupling optical element (which may also be referred to as a light input area on the waveguide), with, e.g., incoupling optical element 1203 disposed on a major surface (e.g., an upper major surface) of waveguide 1202, incoupling optical element 1205 disposed on a major surface (e.g., an upper major surface) of waveguide 1204, and incoupling optical element 1207 disposed on a major surface (e.g., an upper major surface) of waveguide 1206. In some embodiments, one or more of the incoupling optical elements may be disposed on the bottom major surface of the respective waveguide (particularly where one or more incoupling optical elements are reflective, deflecting optical elements). As illustrated, the incoupling optical element 1203, the incoupling optical element 1205, and the incoupling optical element 1207 may be disposed on the upper major surface of waveguide 1202, waveguide 1204, and waveguide 1206, respectively (or the top of the next lower waveguide), particularly where those incoupling optical elements are transmissive, deflecting optical elements. In some embodiments, the incoupling optical element 1203, the incoupling optical element 1205, and the incoupling optical element 1207 may be disposed in the body of the waveguide 1202, waveguide 1204, and waveguide 1206, respectively. In some embodiments, as discussed herein, the incoupling optical element 1203, the incoupling optical element 1205, and the incoupling optical element 1207 are wavelength-selective, such that they selectively redirect one or more wavelengths of light, while transmitting other wavelengths of light. While illustrated on one side or corner of waveguide 1202, waveguide 1204, and waveguide 1206, respectively, it will be appreciated that the incoupling optical element 1203, the incoupling optical element 1205, and the incoupling optical element 1207 may be disposed in other areas of waveguide 1202, waveguide 1204, and waveguide 1206, respectively, in some embodiments.

As illustrated, the incoupling optical element 1203, the incoupling optical element 1205, and the incoupling optical element 1207 may be laterally offset from one another. In some embodiments, each incoupling optical element may be offset such that it receives light without that light passing through another incoupling optical element. For example, each of the incoupling optical element 1203, the incoupling optical element 1205, and the incoupling optical element 1207 may be configured to receive light from a different projector and may be separated (e.g., laterally spaced apart) from other incoupling optical elements such that it substantially does not receive light from the other ones of the incoupling optical elements.

Each waveguide also includes associated light distributing elements, with, e.g., light distributing elements 1210 disposed on a major surface (e.g., a top major surface) of waveguide 1202, light distributing elements 1212 disposed on a major surface (e.g., a top major surface) of waveguide 1204, and light distributing elements 1214 disposed on a major surface (e.g., a top major surface) of waveguide 1206. In some other embodiments, the light distributing elements 1210, the light distributing elements 1212, and the light distributing elements 1214 may be disposed on a bottom major surface of associated waveguide 1202, waveguide 1204, and waveguide 1206, respectively. In some other embodiments, the light distributing elements 1210, the light distributing elements 1212, and the light distributing elements 1214 may be disposed on both top and bottom major surfaces of associated waveguide 1202, waveguide 1204, and waveguide 1206, respectively; or the light distributing elements 1210, the light distributing elements 1212, and the light distributing elements 1214 may be disposed on different ones of the top and bottom major surfaces in different associated waveguide 1202, waveguide 1204, and waveguide 1206, respectively.

Waveguide 1202, waveguide 1204, and waveguide 1206 may be spaced apart and separated by, e.g., gas, liquid, and/or solid layers of material. For example, as illustrated in FIG. 12A, layer 1208 may separate waveguide 1202 and waveguide 1204 and layer 1209 may separate waveguide 1204 and waveguide 1206. In some embodiments, layer 1208 and layer 1209 are formed of low refractive index materials (that is, materials having a lower refractive index than the material forming the immediately adjacent one of waveguide 1202, waveguide 1204, or waveguide 1206). Preferably, the refractive index of the material forming layer 1208 and/or layer is 0.05 or more, or 0.10 or less than the refractive index of the material forming the waveguide 1202, the waveguide 1204, or the waveguide 1206. Advantageously, layer 1208 and layer 1209 having the lower refractive index may function as cladding layers that facilitate total internal reflection (TIR) of light through the waveguide 1202, the waveguide 1204, and the waveguide 1206 (e.g., TIR between the top and bottom major surfaces of each waveguide). In some embodiments, the layer 1208 and the layer 1209 are formed of air. While not illustrated, it will be appreciated that the top and bottom of the illustrated set of stacked waveguides 1200 may include immediately neighboring cladding layers.

Preferably, for ease of manufacturing and other considerations, the material forming the waveguide 1202, the waveguide 1204, and the waveguide 1206 are similar or the same, and the material forming the layer 1208 and the layer 1209 are similar or the same. In some embodiments, the material forming the waveguide 1202, the waveguide 1204, and the waveguide may be different between one or more waveguides, and/or the material forming the layer and the layer 1209 may be different, while still holding to the various refractive index relationships noted above.

With continued reference to FIG. 12A, light ray 1218, light ray 1219, and light ray are incident on the set of stacked waveguides 1200. It will be appreciated that the light ray 1218, the light ray 1219, and the light ray 1220 may be injected into the waveguide 1202, the waveguide 1204, and the waveguide 1206 by one or more projectors (not shown).

In some embodiments, light ray 1218, the light ray 1219, and the light ray 1220 have different properties, e.g., different wavelengths or different ranges of wavelengths, which may correspond to different colors. The incoupling optical element 1203, the incoupling optical element 1205, and the incoupling optical element 1207 each deflect the incident light such that the light propagates through a respective one of the waveguide 1202, the waveguide 1204, or the waveguide 1206 by TIR. In some embodiments, the incoupling optical element 1203, the incoupling optical element 1205, and the incoupling optical element 1207 each selectively deflect one or more particular wavelengths of light, while transmitting other wavelengths to an underlying waveguide and associated incoupling optical element.

For example, incoupling optical element 1203 may be configured to deflect light ray 1218, which has a first wavelength or range of wavelengths, while transmitting light ray 1219 and light ray 1220, which have different second and third wavelengths or ranges of wavelengths, respectively. The light ray 1219 transmitted through the waveguide 1202 impinges on and is deflected by the incoupling optical element 1205, which is configured to deflect light of a second wavelength or range of wavelengths. The light ray 1220 is deflected by the incoupling optical element 1207, which is configured to selectively deflect light of third wavelength or range of wavelengths.

With continued reference to FIG. 12A, the light ray 1218, the light ray 1219, and the light ray 1220 are deflected such that they propagate through corresponding waveguide 1202, waveguide 1204, and waveguide 1206, respectively; that is, the incoupling optical element 1203, the incoupling optical element 1205, and the incoupling optical element 1207 of each waveguide deflects the light into the corresponding waveguide 1202, waveguide 1204, or waveguide 1206 to incouple light into that corresponding waveguide. The light ray 1218, the light ray 1219, and the light ray 1220 are deflected at angles that cause the light to propagate through the respective waveguide 1202, waveguide 1204, and waveguide 1206 by TIR. The light ray 1218, the light ray 1219, and the light ray 1220 propagate through the respective waveguide 1202, waveguide 1204, and waveguide 1206 by TIR until impinging on the waveguide's corresponding light distributing elements: the light distributing elements 1210, the light distributing elements 1212, and the light distributing elements 1214, where they are outcoupled to provide out-coupled light rays 1216.

With reference now to FIG. 12B, a perspective view of an example of the set of stacked waveguides 1200 of FIG. 12A is illustrated. As noted above, the light ray 1218, the light ray 1219, and the light ray 1220 are incoupled and deflected by the incoupling optical element 1203, the incoupling optical element 1205, and the incoupling optical element 1207, respectively, and then propagate by TIR within the waveguide 1202, the waveguide 1204, and the waveguide 1206, respectively. The light ray 1218, the light ray 1219, and the light ray 1220 then impinge on the light distributing elements 1210, the light distributing elements 1212, and the light distributing elements 1214, respectively. The light distributing elements 1210, the light distributing elements 1212, and the light distributing elements 1214 deflect the light ray 1218, the light ray 1219, and the light ray 1220 so that they propagate towards the outcoupling optical elements 1222, the outcoupling optical elements 1224, and the outcoupling optical elements 1226, respectively.

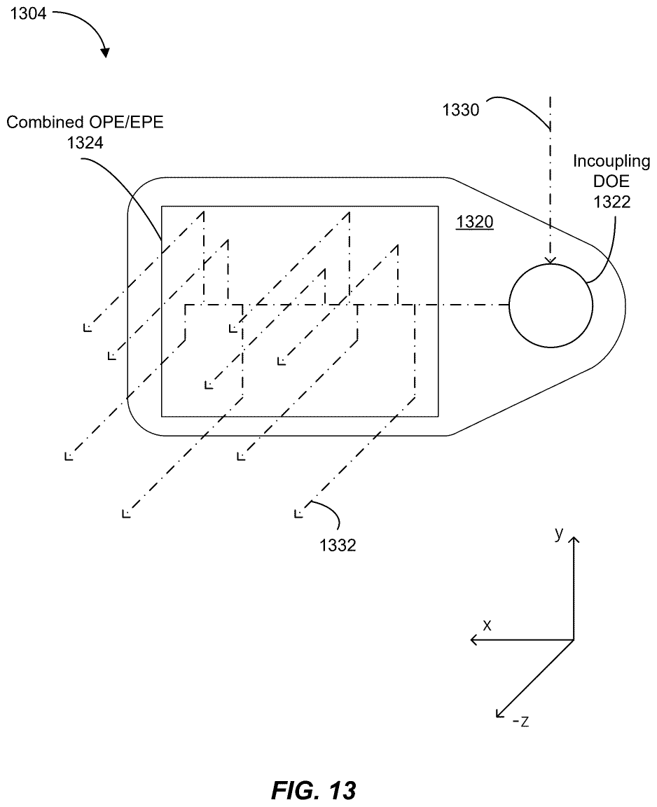

In some embodiments, the light distributing elements 1210, the light distributing elements 1212, and the light distributing elements 1214 are orthogonal pupil expanders (OPEs). In some embodiments, the OPEs deflect or distribute light to the outcoupling optical elements 1222, the outcoupling optical elements 1224, and the outcoupling optical elements 1226 and, in some embodiments, may also increase the beam or spot size of this light as it propagates to the outcoupling optical elements. In some embodiments, the light distributing elements 1210, the light distributing elements 1212, and the light distributing elements 1214 may be omitted and the incoupling optical element 1203, the incoupling optical element 1205, and the incoupling optical element 1207 may be configured to deflect light directly to the outcoupling optical elements 1222, the outcoupling optical elements 1224, and the outcoupling optical elements 1226. For example, with reference to FIG. 12A, the light distributing elements 1210, the light distributing elements 1212, and the light distributing elements 1214 may be replaced with the outcoupling optical elements 1222, the outcoupling optical elements 1224, and the outcoupling optical elements 1226, respectively. In some embodiments, the outcoupling optical elements 1222, the outcoupling optical elements 224, and the outcoupling optical elements 1226 are exit pupils (EPs) or exit pupil expanders (EPEs) that direct light to the eye of the user. It will be appreciated that the OPEs may be configured to increase the dimensions of the eye box in at least one axis and the EPEs may be configured to increase the eye box in an axis crossing, e.g., orthogonal to, the axis of the OPEs. For example, each OPE may be configured to redirect a portion of the light striking the OPE to an EPE of the same waveguide, while allowing the remaining portion of the light to continue to propagate down the waveguide. Upon impinging on the OPE again, another portion of the remaining light is redirected to the EPE, and the remaining portion of that portion continues to propagate further down the waveguide, and so on. Similarly, upon striking the EPE, a portion of the impinging light is directed out of the waveguide towards the user, and a remaining portion of that light continues to propagate through the waveguide until it strikes the EPE again, at which time another portion of the impinging light is directed out of the waveguide, and so on. Consequently, a single beam of incoupled light may be “replicated” each time a portion of that light is redirected by an OPE or EPE, thereby forming a field of cloned beams of light. In some embodiments, the OPE and/or EPE may be configured to modify a size of the beams of light. In some embodiments, the functionality of the light distributing elements 1210, the light distributing elements 1212, and the light distributing elements 1214 and the outcoupling optical elements 1222, the outcoupling optical elements 1224, and the outcoupling optical elements 1226 are combined in a combined pupil expander as discussed in relation to FIG. 13.

Accordingly, with reference to FIGS. 12A and 12B, in some embodiments, the set of stacked waveguides 1200 includes the waveguide 1202, the waveguide 1204, and the waveguide 1206; the incoupling optical element 1203, the incoupling optical element 1205, and the incoupling optical element 1207; the light distributing elements 1210, the light distributing elements 1212, and the light distributing elements 1214 (e.g., OPEs); and the outcoupling optical elements 1222, the outcoupling optical elements 1224, and the outcoupling optical elements (e.g., EPs) for each component color. The waveguide 1202, the waveguide 1204, and the waveguide 1206 may be stacked with an air gap/cladding layer between each one. The incoupling optical element 1203, the incoupling optical element 1205, and the incoupling optical element 1207 redirect or deflect incident light (with different incoupling optical elements receiving light of different wavelengths) into its waveguide. The light then propagates at an angle which will result in TIR within the waveguide 1202, the waveguide 1204, and the waveguide 1206, respectively. In the example shown, light ray 1218 (e.g., blue light) is deflected by the incoupling optical element 1203, and then continues to bounce down the waveguide, interacting with the light distributing element 1210 (e.g., OPEs) and then the outcoupling optical element 1222 (e.g., EPEs), in a manner described earlier. The light ray 1219 and the light ray (e.g., green and red light, respectively) will pass through the waveguide 1202, with light ray 1219 impinging on and being deflected by incoupling optical element 1205. The light ray then bounces down the waveguide 1204 via TIR, proceeding on to its light distributing element 1212 (e.g., OPEs) and then the outcoupling optical element 1224 (e.g., EPs). Finally, light ray 1220 (e.g., red light) passes through the waveguide 1206 to impinge on the incoupling optical element 1207 of the waveguide 1206. The incoupling optical element 1207 deflects the light ray 1220 such that the light ray propagates to light distributing element 1214 (e.g., OPEs) by TIR, and then to the outcoupling optical element 1226 (e.g., EPs) by TIR. The outcoupling optical element 1226 then finally out-couples the light ray 1220 to the viewer, who also receives the outcoupled light from the other waveguides: the waveguide 1202 and the waveguide 1204.

FIG. 12C illustrates a top-down, plan view of an example of the set of stacked waveguides 1200 of FIGS. 12A and 12B. As illustrated, the waveguide 1202, the waveguide 1204, and the waveguide 1206, along with each waveguide's associated light distributing element: the light distributing element 1210, light distributing element 1212, and light distributing element 1214 and the associated outcoupling optical elements: the outcoupling optical elements 1222, the outcoupling optical elements 1224, and the outcoupling optical elements 1226, may be vertically aligned. However, as discussed herein, the incoupling optical element 1203, the incoupling optical element 1205, and the incoupling optical element 1207 are not vertically aligned; rather, the incoupling optical elements are preferably nonoverlapping (e.g., laterally spaced apart as seen in the top-down or plan view). As discussed further herein, this nonoverlapping spatial arrangement facilitates the injection of light from different resources into different waveguides on a one-to-one basis, thereby allowing a specific light source to be uniquely coupled to a specific waveguide. In some embodiments, arrangements including nonoverlapping spatially separated incoupling optical elements may be referred to as a shifted pupil system, and the incoupling optical elements within these arrangements may correspond to sub pupils.

FIG. 13 is a simplified illustration of an eyepiece waveguide having a combined pupil expander according to an embodiment of the present invention. In the example illustrated in FIG. 13, the eyepiece 1304 utilizes a combined OPE/EPE region in a single-side configuration. Referring to FIG. 13, the eyepiece 1304 includes a substrate 1320 in which incoupling optical element 1322 and a combined OPE/EPE region 1324, also referred to as a combined pupil expander (CPE), are provided. Incident light ray 1330 is incoupled via the incoupling optical element 1322 and outcoupled as output light rays 1332 via the combined OPE/EPE region 1324.

The combined OPE/EPE region 1324 includes gratings corresponding to both an OPE and an EPE that spatially overlap in the x-direction and the y-direction. In some embodiments, the gratings corresponding to both the OPE and the EPE are located on the same side of a substrate 1320 such that either the OPE gratings are superimposed onto the EPE gratings or the EPE gratings are superimposed onto the OPE gratings (or both). In other embodiments, the OPE gratings are located on the opposite side of the substrate 1320 from the EPE gratings such that the gratings spatially overlap in the x-direction and the y-direction but are separated from each other in the z-direction (i.e., in different planes). Thus, the combined OPE/EPE region 1324 can be implemented in either a single-sided configuration or in a two-sided configuration.

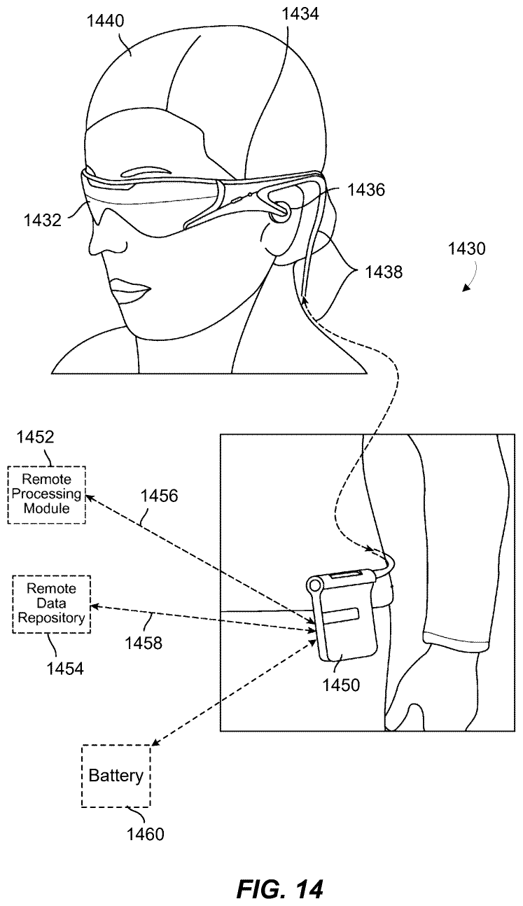

FIG. 14 illustrates an example of wearable display system 1430 into which the various waveguides and related systems disclosed herein may be integrated. With reference to FIG. 14, the wearable display system 1430 includes a display 1432, and various mechanical and electronic modules and systems to support the functioning of the display 1432. The display 1432 may be coupled to a frame 1434, which is wearable by a user 1440 (also referred to as a viewer or a display system user) and which is configured to position the display 1432 in front of the eyes of the user 1440. The display 1432 may be considered eyewear in some embodiments. In some embodiments, a speaker 1436 is coupled to the frame 1434 and configured to be positioned adjacent to the ear canal of the user 1440 (in some embodiments, another speaker, not shown, may optionally be positioned adjacent to the other ear canal of the user to provide stereo/shapeable sound control). The wearable display system 1430 may also include one or more microphones or other devices to detect sound. In some embodiments, the microphone is configured to allow the user to provide inputs or commands to the wearable display system 1430 (e.g., the selection of voice menu commands, natural language questions), and/or may allow audio communication with other persons (e.g., with other users of similar display systems). The microphone may further be configured as a peripheral sensor to collect audio data (e.g., sounds from the user and/or environment). In some embodiments, the wearable display system 1430 may further include one or more outwardly directed environmental sensors configured to detect objects, stimuli, people, animals, locations, or other aspects of the world around the user. For example, environmental sensors may include one or more cameras, which may be located, for example, facing outward so as to capture images similar to at least a portion of an ordinary field of view of the user 1440. In some embodiments, the wearable display system may also include a peripheral sensor, which may be separate from the frame 1434 and attached to the body of the user 1440 (e.g., on the head, torso, an extremity, of the user 1440). The peripheral sensor may be configured to acquire data characterizing a physiological state of the user 1440 in some embodiments. For example, the sensor may be an electrode.

The display 1432 is operatively coupled by a communications link, such as by a wired lead or wireless connectivity, to a local data processing module which may be mounted in a variety of configurations, such as fixedly attached to the frame 1434, fixedly attached to a helmet or hat worn by the user, embedded in headphones, or otherwise removably attached to the user (e.g., in a backpack-style configuration, in a belt-coupling style configuration). Similarly, the sensor may be operatively coupled by a communications link, e.g., a wired lead or wireless connectivity, to the local processor and data module. The local processing and data module may comprise a hardware processor, as well as digital memory, such as non-volatile memory (e.g., flash memory or hard disk drives), both of which may be utilized to assist in the processing, caching, and storage of data. Optionally, the local processor and data module may include one or more central processing units (CPUs), graphics processing units (GPUs), dedicated processing hardware, and so on. The data may include data a) captured from sensors (which may be, e.g., operatively coupled to the frame 1434 or otherwise attached to the user 1440), such as image capture devices (such as cameras), microphones, inertial measurement units, accelerometers, compasses, GPS units, radio devices, gyros, and/or other sensors disclosed herein; and/or b) acquired and/or processed using remote processing module 1452 and/or remote data repository (including data relating to virtual content), possibly for passage to the display 1432 after such processing or retrieval. The local processing and data module may be operatively coupled by communication links 1438 such as via wired or wireless communication links, to the remote processing and data module 1450, which can include the remote processing module 1452, the remote data repository 1454, and a battery 1460. The remote processing module 1452 and the remote data repository 1454 can be coupled by communication links 1456 and communication links 1458 to remote processing and data module 1450 such that these remote modules are operatively coupled to each other and available as resources to the remote processing and data module 1450. In some embodiments, the remote processing and data module 1450 may include one or more of the image capture devices, microphones, inertial measurement units, accelerometers, compasses, GPS units, radio devices, and/or gyros. In some other embodiments, one or more of these sensors may be attached to the frame 1434, or may be standalone structures that communicate with the remote processing and data module 1450 by wired or wireless communication pathways.

With continued reference to FIG. 14, in some embodiments, the remote processing and data module 1450 may comprise one or more processors configured to analyze and process data and/or image information, for instance including one or more central processing units (CPUs), graphics processing units (GPUs), dedicated processing hardware, and so on. In some embodiments, the remote data repository 1454 may comprise a digital data storage facility, which may be available through the internet or other networking configuration in a “cloud” resource configuration. In some embodiments, the remote data repository 1454 may include one or more remote servers, which provide information, e.g., information for generating augmented reality content, to the local processing and data module and/or the remote processing and data module 1450. In some embodiments, all data is stored and all computations are performed in the local processing and data module, allowing fully autonomous use from a remote module.

Optionally, an outside system (e.g., a system of one or more processors, one or more computers) that includes CPUs, GPUs, and so on, may perform at least a portion of processing (e.g., generating image information, processing data) and provide information to, and receive information from, the illustrated modules, for instance, via wireless or wired connections.

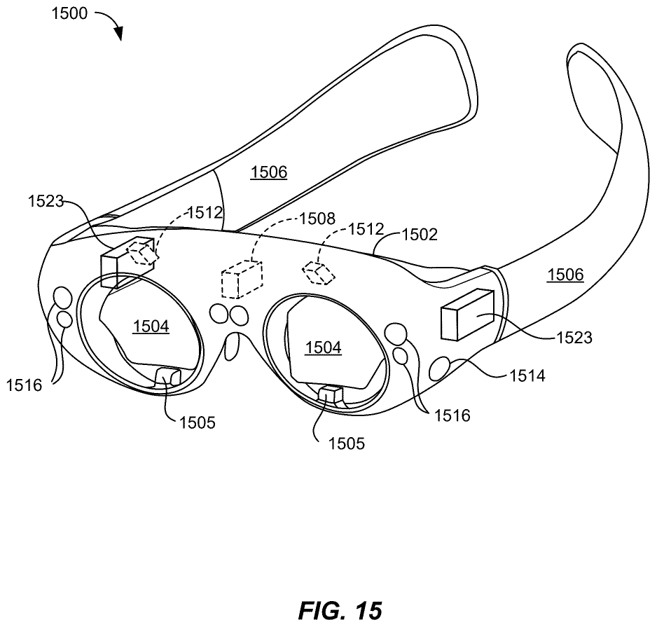

FIG. 15 shows a perspective view of a wearable device 1500 according to an embodiment of the present invention. Wearable device 1500 includes a frame 1502 configured to support one or more projectors 1523 at various positions along an interior-facing surface of frame 1502, as illustrated. In some embodiments, projectors 1523 can be attached at positions near temples 1506. Alternatively, or in addition, another projector could be placed in position 1508. Such projectors may, for instance, include or operate in conjunction with one or more liquid crystal on silicon (LCoS) modules, micro-LED displays, or fiber scanning devices. In some embodiments, light from projectors 1523 or projectors disposed in position 1508 could be guided into eyepieces 1504 for display to eyes of a user. Projectors placed at positions 1512 can be somewhat smaller on account of the close proximity this gives the projectors to the waveguide system. The closer proximity can reduce the amount of light lost as the waveguide system guides light from the projectors to eyepiece 1504. In some embodiments, the projectors at positions can be utilized in conjunction with projectors 1523 or projectors disposed in position 1508. While not depicted, in some embodiments, projectors could also be located at positions beneath eyepieces 1504. Wearable device 1500 is also depicted including sensors 1514 and sensors 1516. Sensors 1514 and sensors 1516 can take the form of forward-facing and lateral-facing optical sensors configured to characterize the real-world environment surrounding wearable device 1500.

Embodiments of the present invention utilize an eye tracking system to determine the eye gaze location of the user and utilize the eye gaze location for image compression processes. Referring to FIG. 15, eye tracking cameras 1505 are located on the frame 1502 and can be utilized to track the eye gaze location of the user using the wearable device 1500. In other embodiments, other eye tracking systems are utilized to determine the eye gaze location and the eye tracking cameras 1505 illustrated in FIG. 15 are merely exemplary. As described more fully herein, the image compression processes utilized to compress and decompress virtual content for storage in memory, internal communications, and display, among other functions, can be modified depending on the eye gaze location, for example, portions of an image or video stream corresponding to the eye gaze location can be compressed using a higher quality compression process compared to other portions of the image or video stream that are located more distant from the eye gaze location. Since these more distant portions of the image or video stream are in the user's peripheral vision, any impact on the user experience resulting from the reduction in compression quality can be less than the benefits achieved in terms of memory and processing efficiency and/or requirements. One of ordinary skill in the art would recognize many variations, modifications, and alternatives.

Various examples of the present disclosure are provided below. As used below, any reference to a series of examples is to be understood as a reference to each of those examples disjunctively (e.g., “Examples 1-4” is to be understood as “Examples 1, 2, 3, or 4”).

Example 1 is a method comprising: rendering an original image at a first processor; encoding the original image to provide an encoded image; transmitting the encoded image to a second processor; decoding the encoded image to provide a decoded image; determining an eye gaze location; splitting the decoded image into N sections based on the eye gaze location; processing N-1 sections of the N sections to produce N-1 secondary quality sections; processing one section of the N sections to provide one primary quality section; combining the one primary quality section and the N-1 secondary quality sections to form a foveated image; and transmitting the foveated image to a display.

Example 2 is the method of example 1 wherein the first processor comprises a graphics processing unit and the second processor comprises a display driver.

Example 3 is the method of example(s) 1-2 wherein the one primary quality section includes pixels corresponding to the eye gaze location.

Example 4 is the method of example(s) 1-3 wherein processing the N-1 sections of the N sections to produce the N-1 secondary quality sections comprises compressing the N-1 sections using a lossy compression process.

Example 5 is the method of example(s) 1-4 wherein the original image comprises an M×N image and the N-1 secondary quality sections comprise M×N images.

Example 6 is the method of example(s) 1-5 wherein processing the N-1 sections of the N sections to produce the N-1 secondary quality sections comprises subsampling the N-1 sections.

Example 7 is the method of example(s) 1-6 wherein the original image comprises an M×N image and the N-1 secondary quality sections comprise αM×αN images, where α<1.

Example 8 is the method of example(s) 1-7 further comprising warping the foveated image prior to transmitting the foveated image to the display.

Example 9 is the method of example(s) 1-8 further comprising determining an eye gaze velocity, wherein pixel dimensions of the one primary quality section are a function of the eye gaze velocity.

Example 10 is the method of example(s) 1-9 wherein: the eye gaze location comprises an eye gaze region; and the one primary quality section includes pixels corresponding to the eye gaze region.

Example, 11 is a method comprising: determining an eye gaze location; rendering, at a first processor, a first image having a first image quality and a second image having a second image quality, wherein the first image quality is higher than the second image quality; encoding the first image to provide a first encoded image; encoding the second image to provide a second encoded image; transmitting the first encoded image and the second encoded image to a second processor; decoding the first encoded image and the second encoded image to provide a first decoded image and a second decoded image; combining the first decoded image and the second decoded image to form a foveated image; and transmitting the foveated image to a display.

Example 12 is the method of example 11 wherein the first processor comprises a graphics processing unit and the second processor comprises a display driver.

Example 13 is the method of example(s) 11-12 wherein the first image includes pixels corresponding to the eye gaze location.

Example 14 is the method of example(s) 11-13 further comprising: compressing the first decoded image using a lossless compression process; compressing the second decoded image using a lossless compression process; and storing the compressed first decoded image and the compressed second decoded image in memory.

Example 15 is the method of example(s) 11-14 wherein: the compressed first decoded image comprises an M×N image; the compressed second decoded image comprises an M×N image; and the foveated image comprises a 2M×2N image.

Example 16 is the method of example(s) 11-15 wherein the foveated image comprises an M×N image and the first image and the second image comprise αM×αN images, where α<1.

Example 17 is the method of example(s) 11-16 further comprising warping the foveated image prior to transmitting the foveated image to the display.

Example 18 is the method of example(s) 11-17 wherein determining the eye gaze location is performed at a first frame rate and rendering the first image and the second image is performed at a second frame rate higher than the first frame rate.

Example 19 is the method of example(s) 11-18 further comprising displaying the foveated image at the second frame rate.

Example 20 is the method of example(s) 11-19 wherein the first image has a rectangular shape centered at the eye gaze location.

It is also understood that the examples and embodiments described herein are for illustrative purposes only and that various modifications or changes in light thereof will be suggested to persons skilled in the art and are to be included within the spirit and purview of this application and scope of the appended claims.

What is claimed is:

1. A method comprising:
rendering an original image at a first processor;
encoding the original image to provide an encoded image;
transmitting the encoded image to a second processor;
decoding the encoded image to provide a decoded image;
determining an eye gaze location;
splitting the decoded image into N sections based on the eye gaze location;
processing N-1 sections of the N sections to produce N-1 secondary quality sections;
processing one section of the N sections to provide one primary quality section;
combining the one primary quality section and the N-1 secondary quality sections to form a foveated image; and
transmitting the foveated image to a display.

2. The method of claim 1 wherein the first processor comprises a graphics processing unit and the second processor comprises a display driver.

3. The method of claim 1 wherein the one primary quality section includes pixels corresponding to the eye gaze location.

4. The method of claim 1 wherein processing the N-1 sections of the N sections to produce the N-1 secondary quality sections comprises compressing the N-1 sections using a lossy compression process.

5. The method of claim 4 wherein the original image comprises an M×N image and the N-1 secondary quality sections comprise M×N images.

6. The method of claim 1 wherein processing the N-1 sections of the N sections to produce the N-1 secondary quality sections comprises subsampling the N-1 sections.

7. The method of claim 6 wherein the original image comprises an M×N image and the N-1 secondary quality sections comprise αM×αN images, where α<1.

8. The method of claim 1 further comprising warping the foveated image prior to transmitting the foveated image to the display.

9. The method of claim 1 further comprising determining an eye gaze velocity, wherein pixel dimensions of the one primary quality section are a function of the eye gaze velocity.

10. The method of claim 1 wherein:
the eye gaze location comprises an eye gaze region; and
the one primary quality section includes pixels corresponding to the eye gaze region.

11. A method comprising:
determining an eye gaze location;
rendering, at a first processor, a first image having a first image quality and a second image having a second image quality, wherein the first image quality is higher than the second image quality;
encoding the first image to provide a first encoded image;
encoding the second image to provide a second encoded image;
transmitting the first encoded image and the second encoded image to a second processor;
decoding the first encoded image and the second encoded image to provide a first decoded image and a second decoded image;
combining the first decoded image and the second decoded image to form a foveated image; and
transmitting the foveated image to a display.

12. The method of claim 11 wherein the first processor comprises a graphics processing unit and the second processor comprises a display driver.

13. The method of claim 11 wherein the first image includes pixels corresponding to the eye gaze location.

14. The method of claim 11 further comprising:
compressing the first decoded image using a lossless compression process;
compressing the second decoded image using a lossless compression process; and
storing the compressed first decoded image and the compressed second decoded image in memory.

15. The method of claim 14 wherein:
the compressed first decoded image comprises an M×N image;
the compressed second decoded image comprises an M×N image; and
the foveated image comprises a 2M×2N image.

16. The method of claim 11 wherein the foveated image comprises an M×N image and the first image and the second image comprise αM×αN images, where α<1.

17. The method of claim 11 further comprising warping the foveated image prior to transmitting the foveated image to the display.

18. The method of claim 11 wherein determining the eye gaze location is performed at a first frame rate and rendering the first image and the second image is performed at a second frame rate higher than the first frame rate.

19. The method of claim 18 further comprising displaying the foveated image at the second frame rate.

20. The method of claim 11 wherein the first image has a rectangular shape centered at the eye gaze location.
